(19) United States
(12) Patent Application Publication
(10) Pub. No.: US 2016/0249069 A1
(43) Pub. Date: Aug. 25, 2016

(54) ERROR CONCEALMENT MODE SIGNALING FOR A VIDEO TRANSMISSION SYSTEM

(71) Applicant: VID SCALE, INC., Wilmington, DE (US)

(72) Inventors: Eun Seok Ryu, Seoul (KR); Yan Ye, San Diego, CA (US); Yuwen He, San Diego, CA (US); Yong He, San Diego, CA (US)

(73) Assignee: Vid Scale, Inc., Wilmington, DE (US)

(21) Appl. No.: 15/030,952

(22) PCT Filed: Oct. 22, 2014
(86) PCT No.: PCT/US2014/061726

§ 371 Date: Apr. 21, 2016

Related U.S. Application Data
(60) Provisional application No. 61/894,286, filed on Oct. 22, 2013.

(51) Int. Cl. H04N 19/65; H04N 19/177; H04N 19/187; H04N 19/154

(52) U.S. Cl. CPC H04N 19/65; H04N 19/154; H04N 19/177; H04N 19/187

(57) ABSTRACT

Systems, methods, and instrumentalities are disclosed for error concealment mode signaling for a video transmission system. A video coding device may receive a video input comprising a plurality of pictures. The video coding device may select a first picture from the plurality of pictures in the video input. The video coding device may evaluate two or more error concealment modes for the first picture. The error concealment modes may comprises two or more of Picture Copy (PC), Temporal Direct (TD), Motion Copy (MC), Base Layer Skip (BLSkip; Motion & Residual upsampling), Reconstructed BL upsampling (RU), E-ILR Mode 1, and/or E-ILR Mode 2. The video coding device may select an error concealment mode from the two or more evaluated error concealment modes for the first picture. The video coding device may signal the selected error concealment mode for the first picture in a video bitstream.

### CROSS REFERENCE

This application claims the benefit of U.S. Provisional Application No. 61/894,286 filed on Oct. 22, 2013, the entirety of which is incorporated by referenced herein.

### BACKGROUND

The sum of all forms of video (e.g., TV, video on demand (VoD), Internet, and P2P) may be in the range of 80 to 90 percent of global consumer traffic by 2017. Traffic from wireless and mobile devices may exceed traffic from wired devices by 2016. Video-on-demand traffic may nearly triple by 2017. The amount of VoD traffic in 2017 may be equivalent to 6 billion DVDs per month. Content Delivery Network (CDN) traffic may deliver almost two-thirds of all video traffic by 2017. By 2017, 65 percent of all Internet video traffic may cross content delivery networks in 2017, up from 53 percent in 2012.

High efficiency video coding (HEVC) and scalable HEVC (SHVC) may be provided. HEVC and SHVC may not have syntax and semantics for error concealment (EC). MPEG media transport (MMT) may not have any syntax and semantics for the EC.

### SUMMARY

Systems, methods, and instrumentalities are disclosed for error concealment mode signaling for a video transmission system. A video coding device may receive a video input comprising a plurality of pictures. The video coding device may select a first picture from the plurality of pictures in the video input. The video coding device may evaluate two or more error concealment modes for the first picture. The video coding device may select an error concealment mode from the two or more evaluated error concealment modes for the first picture. The video coding device may signal the selected error concealment mode for the first picture in a video bitstream. The video coding device may evaluate the plurality of error concealment modes for a second picture. The video coding device may select an error concealment mode out of the plurality of error concealment modes for the second picture. The video coding device may signal the selected error concealment mode for the second picture and the selected error concealment mode for the first picture in the video bitstream, wherein the selected error concealment mode for the first picture is different from the selected error concealment mode for the second picture.

The video coding device may evaluate the plurality of error concealment modes for a second picture. The video coding device may select an error concealment mode out of the plurality of error concealment modes for the second picture. The video coding device may signal the selected error concealment mode for the second picture and the selected error concealment mode for the first picture in the video bitstream. The selected error concealment mode for the first picture may be the same as the selected error concealment mode for the second picture.

The video coding device may select the error concealment mode based on a disparity between the first picture and an error concealed version of the first picture. The video coding device may select the error concealment mode having a smallest calculated disparity. The disparity may be measured according to one or more of a sum of absolute differences (SAD) or a structural similarity (SSIM) between the first picture and the error concealed version of the first picture determined using the selected EC mode. The disparity may be measured using one or more color components of the first picture.

The plurality of error concealment modes may comprise at least two of Picture Copy (PC), Temporal Direct (TD), Motion Copy (MC), Base Layer Skip (BLSkip: Motion & Residual upsampling), Reconstructed BL upsampling (RU), E-ILR Mode 1, or E-ILR Mode 2.

The video coding device may signal the selected error concealment mode for the first picture in the video bitstream. The video coding device may signal the error concealment mode in a supplemental enhancement information (SEI) message of the video bitstream, an MPEG media transport (MMT) transport packet, or an MMT error concealment mode (ECM) message.

A video coding device may receive a video bitstream comprising a plurality of pictures. The video coding device may receive an error concealment mode for a first picture in the video bitstream. The video coding device may determine that the first picture is lost. The video coding device may perform error concealment for the first picture. The error concealment may be performed using the received error concealment mode for the first picture. The video coding device may receive an error concealment mode for a second picture in the video bitstream. The video coding device may determine that the second picture is lost. The video coding device may perform error concealment for the second picture. Error concealment may be performed using the received error concealment mode for the second picture. The error concealment mode for the second picture may be the same as the error concealment mode for the first picture. The error concealment mode for the second picture may be different than the error concealment mode for the first picture.

A video coding device may receive a video input comprising a plurality of pictures. The video coding device may select a first picture from the plurality of pictures in the video input. The video coding device may evaluate two or more error concealment modes for the first picture. The video coding device may select an error concealment mode from the two or more evaluated error concealment modes for the first picture. The video coding device may signal the selected error concealment mode for the first picture in a video bitstream. The video coding device may select a second picture from the plurality of pictures in the video input. The video coding device may evaluate two or more error concealment modes for the second picture. The video coding device may select an error concealment mode from the two or more evaluated error concealment modes for the second picture. The video coding device may signal the selected error concealment mode for the second picture in the video bitstream. The selected error concealment mode for the first picture may be different from the selected error concealment mode for the second picture. The selected error concealment mode for the first picture may be the same as the selected error concealment mode for the second picture.

The video coding device may evaluate two or more error concealment modes for each picture in the plurality of pictures. The video coding device may divide the plurality of pictures into a first subset of pictures and a second subset of pictures. The video coding device may select an error concealment mode from the two or more evaluated error concealment modes for each picture in the plurality of pictures. The selected error concealment mode for the first subset of pictures may be the same and the selected error concealment mode for the second subset of pictures may be the same. The video coding device may signal the selected error concealment mode for the first subset of pictures and the selected error concealment mode for the second subset of pictures in the video bitstream. The video coding device determine that a higher layer of the video input exists. The higher layer may be higher than a layer comprising the first picture. The video coding device may select a picture from a plurality of pictures in the higher layer of the video input. The video coding device may evaluate two or more error concealment modes for the selected picture of the higher layer. The video coding device may select an error concealment mode from the two or more evaluated error concealment modes for the selected picture from the higher layer. The video coding device may signal the selected error concealment mode for the selected picture of the higher layer in the video bitstream with the error concealment mode for the first picture.

A video coding device may evaluate two or more error concealment modes for a layer. The video coding device may select an error concealment mode from the two or more error concealment modes. The video coding device may signal the selected error concealment mode in a video bitstream for the layer.

### BRIEF DESCRIPTION OF THE DRAWINGS

FIG. 1 depicts an example multi-layer scalable video coding system.

FIG. 2 is a diagram of an example of a video streaming system architecture.

FIG. 3 is a simplified block diagram illustrating an example two-layer scalable video encoder that may be configured to perform HD to UHD scalability.

FIG. 4 is a simplified block diagram illustrating an example two-layer scalable video decoder that may be configured to perform HD to UHD scalability.

FIG. 5 depicts an example of temporal and inter-layer prediction for stereoscopic video coding.

FIG. 6 is a diagram of example of a picture reference relation with hierarchical B pictures.

FIGS. 7A-E are diagrams of example cases of picture losses in a base layer (BL) and/or an enhancement layer (EL) of scalable video coding.

FIG. 8 is a diagram of an example of picture copy.

FIG. 9 is a diagram of an example of temporal direct for a B picture.

FIG. 10A is a diagram of an example of existing EC.

FIG. 10B is a diagram of an example of EC mode signaling.

FIG. 11 is a diagram of example EC mode signaling from the perspective of a video encoding device.

FIG. 12 is a diagram of example EC mode signaling from the perspective of a video decoding device.

FIG. 13 is a diagram of an example of two consecutive pictures that are lost.

FIG. 14 is a diagram of an example of EC mode signaling.

FIG. 15 is a diagram of an example EC mode signaling environment.

FIG. 16 is a diagram of an example of error pattern file generation.

FIG. 17 is a diagram of an example PSNR comparison between EC mode 2 and EC mode 4.

FIG. 18A is a diagram of an example of a multicast group with supportable EC modes.

FIG. 18B is a diagram of an example session initiation with supportable EC modes.

FIG. 19A is a system diagram of an example communications system in which one or more disclosed embodiments may be implemented.

FIG. 19B is a system diagram of an example wireless transmit/receive unit (WTRU) that may be used within the communications system illustrated in FIG. 19A.

FIG. 19C is a system diagram of an example radio access network and an example core network that may be used within the communications system illustrated in FIG. 19A.

FIG. 19D is a system diagram of an example radio access network and another example core network that may be used within the communications system illustrated in FIG. 19A.

FIG. 19E is a system diagram of an example radio access network and another example core network that may be used within the communications system illustrated in FIG. 19A.

FIG. 20 is a diagram of example EC mode signaling.

FIG. 21 is a diagram of example EC mode signaling.

### DETAILED DESCRIPTION

A detailed description of illustrative embodiments will now be described with reference to the various figures. Although this description provides a detailed example of possible implementations, it should be noted that the details are intended to be exemplary and in no way limit the scope of the application.

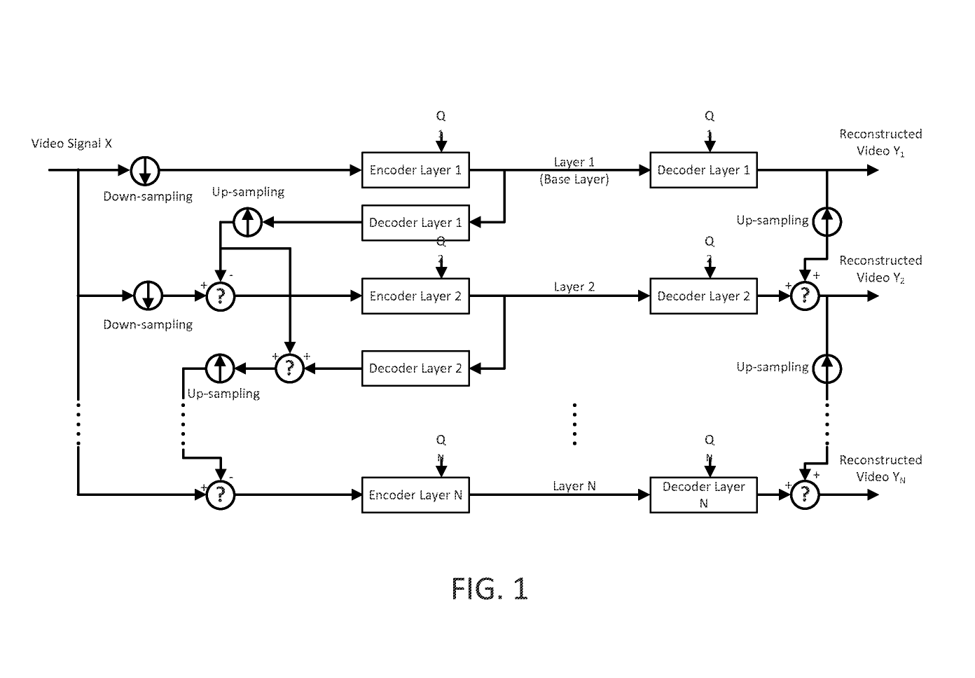

FIG. 1 is a simplified block diagram depicting an example block-based, hybrid scalable video coding (SVC) system. A spatial and/or temporal signal resolution to be represented by the layer 1 (base layer) may be generated by downsampling of the input video signal. In a subsequent encoding stage, a setting of the quantizer such as Q1 may lead to a quality level of the base information. One or more subsequent, higher layer(s) may be encoded and/or decoded using the base-layer reconstruction Y1, which may represent an approximation of higher layer resolution levels. An upsampling unit may perform upsampling of the base layer reconstruction signal to a resolution of layer 2. Downsampling and/or upsampling may be performed throughout a plurality of layers (e.g., for N layers, layers 1, 2 . . . N). Downsampling and/or upsampling ratios may be different, for example depending on a dimension of a scalability between two layers.

In the example scalable video coding system of FIG. 1, for a given higher layer n (e.g., 2≦n≦N, N being the total number of layers), a differential signal may be generated by subtracting an upsampled lower layer signal (e.g., layer n-1 signal) from a current layer n signal. This differential signal may be encoded. If respective video signals represented by two layers, n1 and n2, have the same spatial resolution, corresponding downsampling and/or upsampling operations may be bypassed. A given layer n (e.g., 1≦n≦N), or a plurality of layers, may be decoded without using decoded information from higher layers.

Relying on the coding of a residual signal (e.g., a differential signal between two layers) for layers other than the base layer, for example using the example SVC system of FIG. 1, may cause visual artifacts. Such visual artifacts may be due to, for example, quantization and/or normalization of the residual signal to restrict its dynamic range, and/or quantization performed during coding of the residual. One or more higher layer encoders may adopt motion estimation and/or motion compensated prediction as respective encoding modes. Motion estimation and/or compensation in a residual signal may be different from conventional motion estimation, and may be prone to visual artifacts. In order to reduce (e.g., minimize) the occurrence of visual artifacts, a more sophisticated residual quantization may be implemented, for example along with a joint quantization process that may include both quantization and/or normalization of the residual signal to restrict its dynamic range and quantization performed during coding of the residual. Such a quantization process may increase complexity of the SVC system.

Scalable video coding may enable the transmission and decoding of partial bitstreams. This may enable SVC to provide video services with lower temporal and/or spatial resolutions or reduced fidelity, while retaining a relatively high reconstruction quality (e.g., given respective rates of the partial bitstreams). SVC may be implemented with single loop decoding, such that an SVC decoder may set up one motion compensation loop at a layer being decoded, and may not set up motion compensation loops at one or more other lower layers. For example, a bitstream may include two layers, including a first layer (layer 1) that may be a base layer and a second layer (layer 2) that may be an enhancement layer. When such an SVC decoder reconstructs layer 2 video, the setup of a decoded picture buffer and motion compensated prediction may be limited to layer 2. In such an implementation of SVC, respective reference pictures from lower layers may not be fully reconstructed, which may reduce computational complexity and/or memory consumption at the decoder.

Single loop decoding may be achieved by constrained inter-layer texture prediction, where, for a current block in a given layer, spatial texture prediction from a lower layer may be permitted if a corresponding lower layer block is coded in intra mode. This may be referred to as restricted intra prediction. When a lower layer block is coded in intra mode, it may be reconstructed without motion compensation operations and/or a decoded picture buffer.

SVC may implement one or more additional inter-layer prediction techniques, such as but not limited to, motion vector prediction, residual prediction, mode prediction, etc. from one or more lower layers. This may improve rate-distortion efficiency of an enhancement layer. An SVC implementation with single loop decoding may exhibit reduced computational complexity and/or reduced memory consumption at the decoder, and may exhibit increased implementation complexity, for example due to reliance on block-level inter-layer prediction. To compensate for a performance penalty that may be incurred by imposing a single loop decoding constraint, encoder design and computation complexity may be increased to achieve desired performance. Coding of interlaced content may not be supported by SVC.

Multi-view video coding (MVC) may provide view scalability. In an example of view scalability, a base layer bitstream may be decoded to reconstruct a conventional two dimensional (2D) video, and one or more additional enhancement layers may be decoded to reconstruct other view representations of the same video signal. When such views are combined together and displayed by a three dimensional (3D) display, 3D video with proper depth perception may be produced.

A video coding device may use error concealment (EC) for video transmission services, such as over error prone networks. A video coding device, such as a video decoding device, may have difficulty selecting an EC mode among many EC modes without the video coding device having access to the original pictures. EC modes that work at video decoder side (e.g., only at the decoder side) may be limited.

A video coding device may be configured to send and/or receive EC mode signaling. For example, a video coding device, such as a video encoding device, may simulate various EC modes on a damaged picture. The video encoding device may determine the EC mode that provides a desired disparity (e.g., a minimal disparity) between an original image and a reconstructed image. The video encoding device may signal the calculated EC mode to the video decoder in a client. For example, a client may be a wireless transmit/receive unit (WTRU).

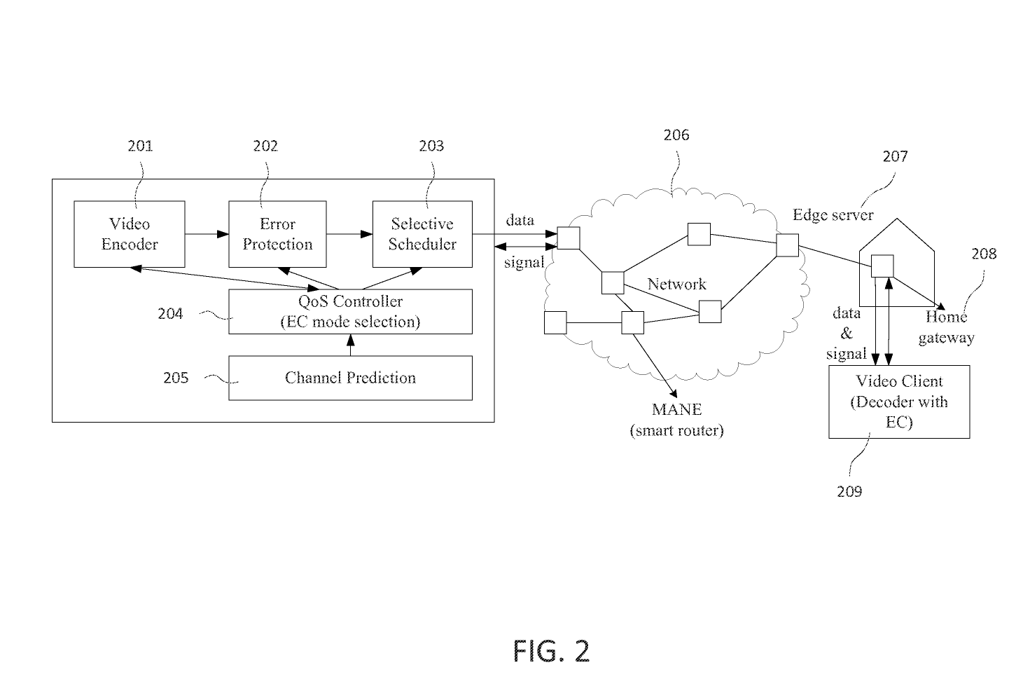

FIG. 2 is a diagram of an example of a video streaming system architecture. The video server may include multiple modules, for example, such as a video encoder 201, error protection 202, selective scheduler 203, quality of service (QoS) controller 204 for streaming and/or channel prediction 205. The video coding device may comprise the functionality of the QoS controller 204. The video client 209 may include an EC module. From a network point of view, the video packet may be transmitted over an error-prone network. The transmission may consider the packet loss that may occur in a wireless connection. Packet loss may occur due to signal interference and/or dropping packets for congestion control. The network 206 may use automatic repeat request (ARQ) and/or forward error correction (FEC) to recover packets from the network error. Transmission delay and/or jitter may occur unpredictably when the network uses ARQ and/or FEC. The cross-layer optimization may avoid the use of retransmission (e.g., ARQ) and/or error protection (e.g., FEC) in the link and physical layers, for example, because of the undesirable delay and jitter. Video content-aware error protection (e.g., unequal error protection (UEP)) and/or EC modes may be used in the application layer.

The video server 207 and/or client 209 may provide error resilient streaming and/or EC modes, for example, along with flow control and/or congestion control. In FIG. 2, the server 207 and client 209 may exchange control messages (e.g., signal) to control QoS metrics. The signaling effort may enhance the overall video quality. Gateways 208 and/or routers may use control messages for resource reservations to keep QoS quality at the application layer. QoS quality at the application layer may be a feature for MPEG Media Transport (MMT).

MPEG frame compatible (MFC) video coding may provide a scalable extension to 3D video coding. For example, MFC may provide a scalable extension to frame compatible base layer video (e.g., two views packed into the same frame), and may provide one or more enhancement layers to recover full resolution views. Stereoscopic 3D video may have two views, including a left and a right view. Stereoscopic 3D content may be delivered by packing and/or multiplexing the two views into one frame, and by compressing and transmitting the packed video. At a receiver side, after decoding, the frames may be unpacked and displayed as two views. Such multiplexing of the views may be performed in the temporal domain or the spatial domain. When performed in the spatial domain, in order to maintain the same picture size, the two views may be spatially downsampled (e.g., by a factor of two and packed in accordance with one or more arrangements. For example, a side-by-side arrangement may put the downsampled left view on the left half of the picture and the downsampled right view on the right half of the picture. Other arrangements may include top-and-bottom, line-by-line, checkerboard, etc. The arrangement used to achieve frame compatible 3D video may be conveyed by one or more frame packing arrangement SEI messages, for example. Although such arrangement may achieve 3D delivery with minimal increase in bandwidth consumption, spatial downsampling may cause aliasing in the views and/or may reduce the visual quality and user experience of 3D video.

A video coding system (e.g., a video coding system in accordance with scalable extensions of high efficiency video coding (SHVC)) may include one or more devices that are configured to perform video coding. A device that is configured to perform video coding (e.g., to encode and/or decode video signals) may be referred to as a video coding device. Such video coding devices may include video-capable devices, for example a television, a digital media player, a DVD player, a Blu-ray™ player, a networked media player device, a desktop computer, a laptop personal computer, a tablet device, a mobile phone, a video conferencing system, a hardware and/or software based video encoding system, or the like. Such video coding devices may include wireless communications network elements, such as a wireless transmit/receive unit (WTRU), a base station, a gateway, or other network elements.

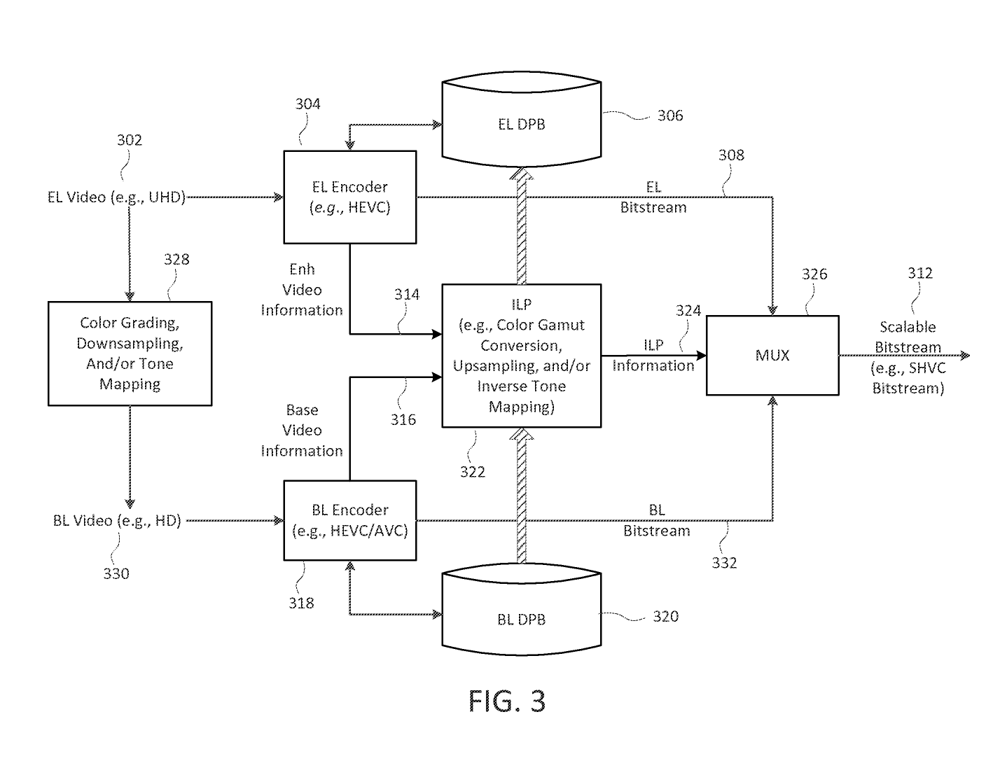

FIG. 3 is a simplified block diagram illustrating an example encoder (e.g., an SHVC encoder). The illustrated example encoder may be used to generate a two-layer HD-to-UHD scalable bitstream. As shown in FIG. 3, the base layer (BL) video input 330 may be an HD video signal, and the enhancement layer (EL) video input 302 may be a UHD video signal. The HD video signal 330 and the UHD video signal 302 may correspond to each other, for example by one or more of: one or more downsampling parameters (e.g., spatial scalability); one or more color grading parameters (e.g., color gamut scalability), or one or more tone mapping parameters (e.g., bit depth scalability) 328.

The BL encoder 318 may include, for example, a high efficiency video coding (HEVC) video encoder or an H.264/AVC video encoder. The BL encoder 318 may be configured to generate the BL bitstream 332 using one or more BL reconstructed pictures (e.g., stored in the BL DPB 320) for prediction. The EL encoder 304 may include, for example, an HEVC encoder. The EL encoder 304 may include one or more high level syntax modifications, for example to support inter-layer prediction by adding inter-layer reference pictures to the EL DPB. The EL encoder 304 may be configured to generate the EL bitstream 808 using one or more EL reconstructed pictures (e.g., stored in the EL DPB 306) for prediction.

One or more reconstructed BL pictures in the BL DPB 320 may be processed, at inter-layer processing (ILP) unit 322, using one or more picture level inter-layer processing techniques, including one or more of upsampling (e.g., for spatial scalability), color gamut conversion (e.g., for color gamut scalability), or inverse tone mapping (e.g., for bit depth scalability). The one or more processed reconstructed BL pictures may be used as reference pictures for EL coding. Inter-layer processing may be performed based on enhancement video information 314 received from the EL encoder 304 and/or the base video information 816 received from the BL encoder 318. This may improve EL coding efficiency.

At 326, the EL bitstream 308, the BL bitstream 332, and the parameters used in inter-layer processing such as ILP information 324, may be multiplexed together into a scalable bitstream 312. For example, the scalable bitstream 312 may include an SHVC bitstream.

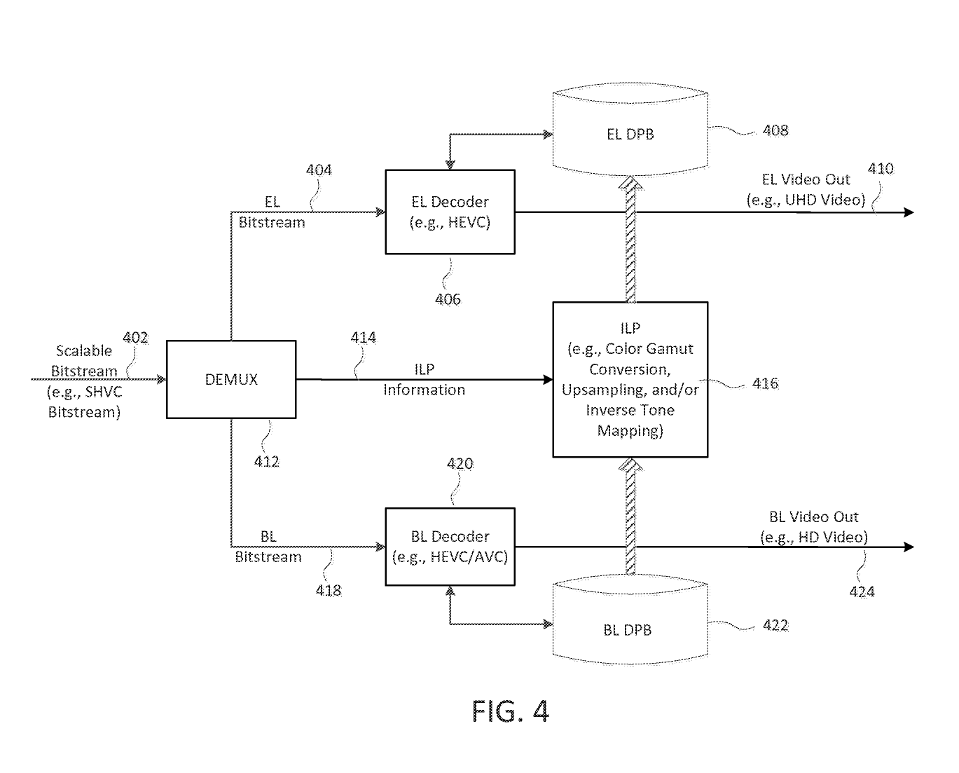

FIG. 4 is a simplified block diagram illustrating an example decoder (e.g., an SHVC decoder) that may correspond to the example encoder depicted in FIG. 3. The illustrated example decoder may be used, for example, to decode a two-layer HD-to-UHD bitstream.

As shown in FIG. 4, a demux module 412 may receive a scalable bitstream 402, and may demultiplex the scalable bitstream 402 to generate ILP information 414, an EL bitstream 404 and a BL bitstream 418. The scalable bitstream 402 may include an SHVC bitstream. The EL bitstream 404 may be decoded by EL decoder 406. The EL decoder 406 may include, for example, an HEVC video decoder. The EL decoder 406 may be configured to generate UHD video signal 410 using one or more EL reconstructed pictures (e.g., stored in the EL DPB 408) for prediction. The BL bitstream 418 may be decoded by BL decoder 420. The BL decoder 420 may include, for example, an HEVC video decoder or an H.264/AVC video. The BL decoder 420 may be configured to generate HD video signal 424 using one or more BL reconstructed pictures (e.g., stored in the BL DPB 422) for prediction. The reconstructed video signals such as UHD video signal 410 and HD video signal 424 may be used to drive the display device.

One or more reconstructed BL pictures in the BL DPB 422 may be processed, at ILP unit 916, using one or more picture level inter-layer processing techniques. Such picture level inter-layer processing techniques may include one or more of upsampling (e.g., for spatial scalability), color gamut conversion (e.g., for color gamut scalability), or inverse tone mapping (e.g., for bit depth scalability). The one or more processed reconstructed BL pictures may be used as reference pictures for EL decoding. Inter-layer processing may be performed based on the parameters used in inter-layer processing such as ILP information 414. The prediction information may comprise prediction block sizes, one of more motion vectors (e.g., which may indicate direction and amount of motion), and/or one or more reference indices (e.g., which may indicate from which reference picture the prediction signal is to be obtained). This may improve EL decoding efficiency.

A reference index based framework may utilize block-level operations similar to block-level operations in a single-layer codec. Single-layer codec logics may be reused within the scalable coding system. A reference index based framework may simplify the scalable codec design. A reference index based framework may provide flexibility to support different types of scalabilities, for example, by appropriate high level syntax signaling and/or by utilizing inter-layer processing modules to achieve coding efficiency. One or more high level syntax changes may support inter-layer processing and/or the multi-layer signaling of SHVC.

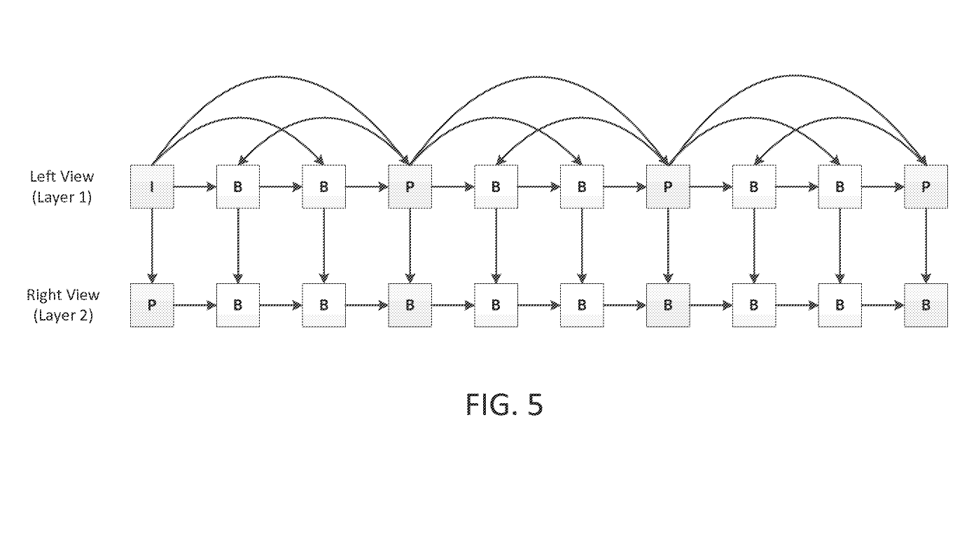

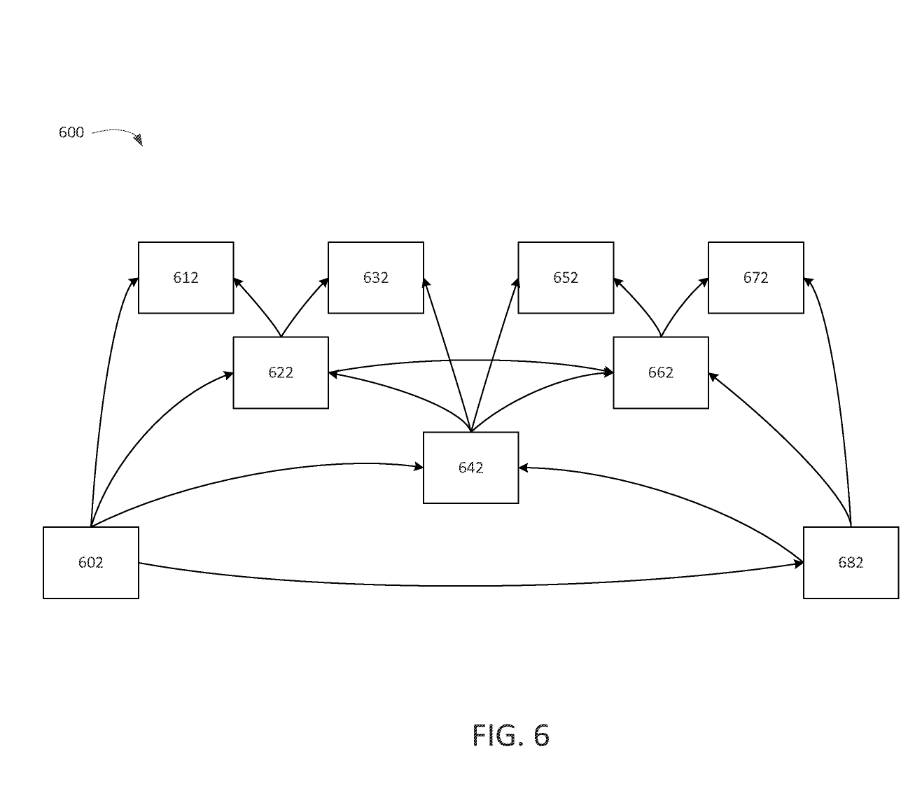

FIG. 5 depicts an example prediction structure for using MVC to code a stereoscopic video with a left view (layer 1) and a right view (layer 2). The left view video may be coded with an I-B-B-P prediction structure, and the right view video may be coded with a P-B-B-B prediction structure. As shown in FIG. 5, in the right view, the first picture collocated with the first I picture in the left view may be coded as a P picture, and subsequent pictures in the right view may be coded as B pictures with a first prediction coming from temporal references in the right view, and a second prediction coming from inter-layer reference in the left view. MVC may not support the single loop decoding feature. For example, as shown in FIG. 5, decoding of the right view (layer 2) video may be conditioned on the availability of an entirety of pictures in the left view (layer 1), with each layer (view) having a respective compensation loop. An implementation of MVC may include high level syntax changes, and may not include block-level changes. This may ease implementation of MVC. For example, MVC may be implemented by configuring reference pictures at the slice and/or picture level. MVC may support coding of more than two views, for instance by extending the example shown in FIG. 3 to perform inter-layer prediction across multiple views.

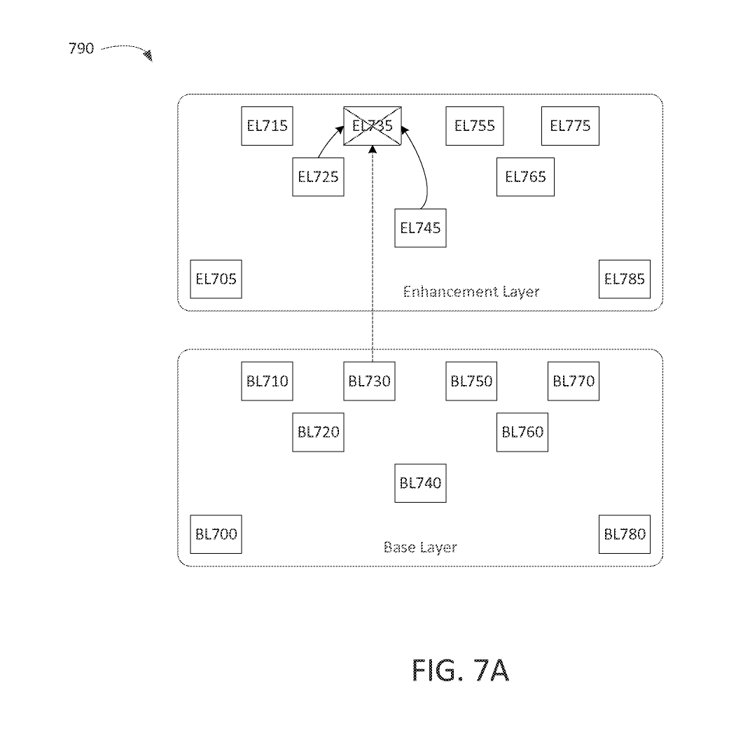

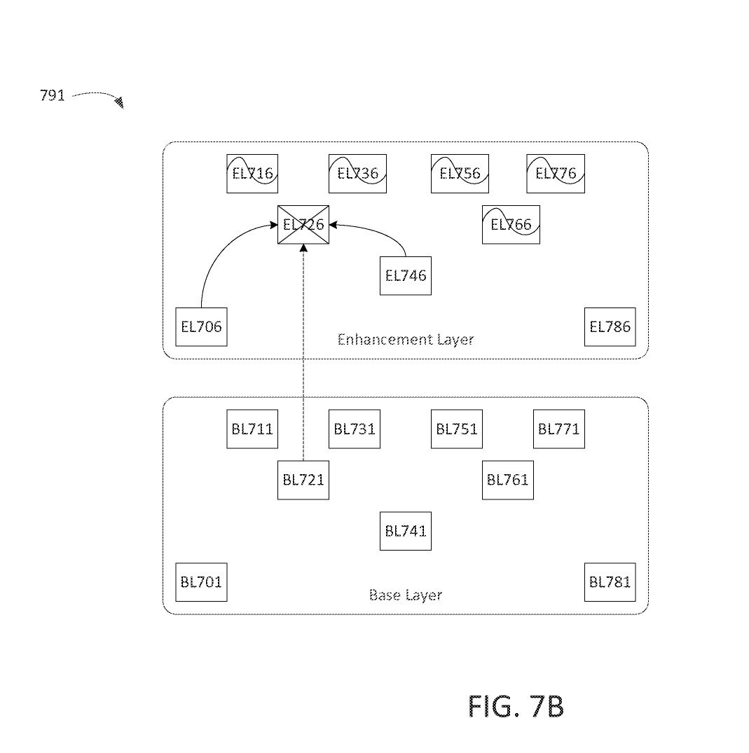

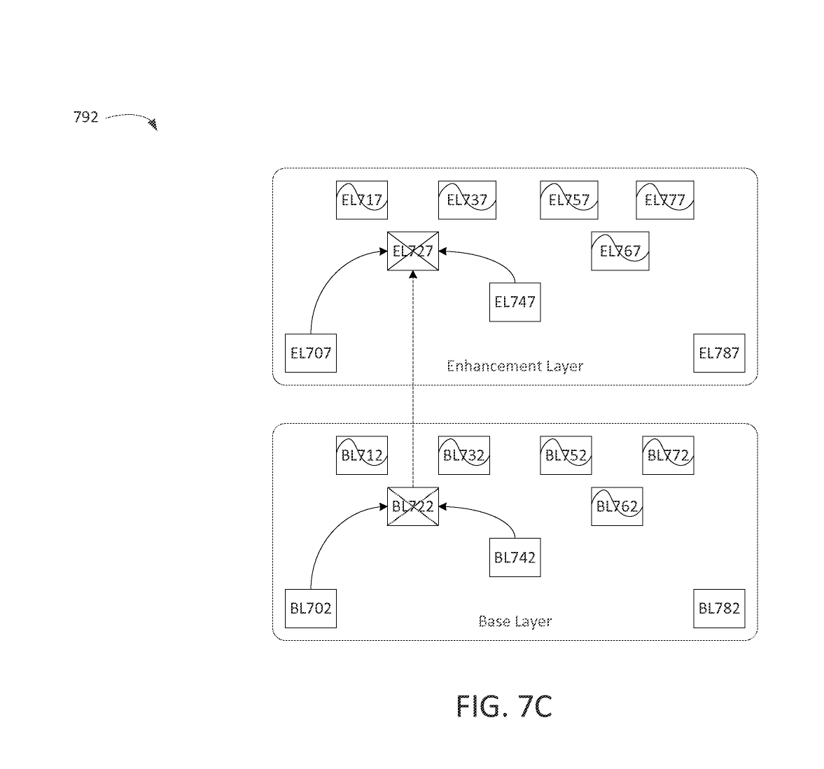

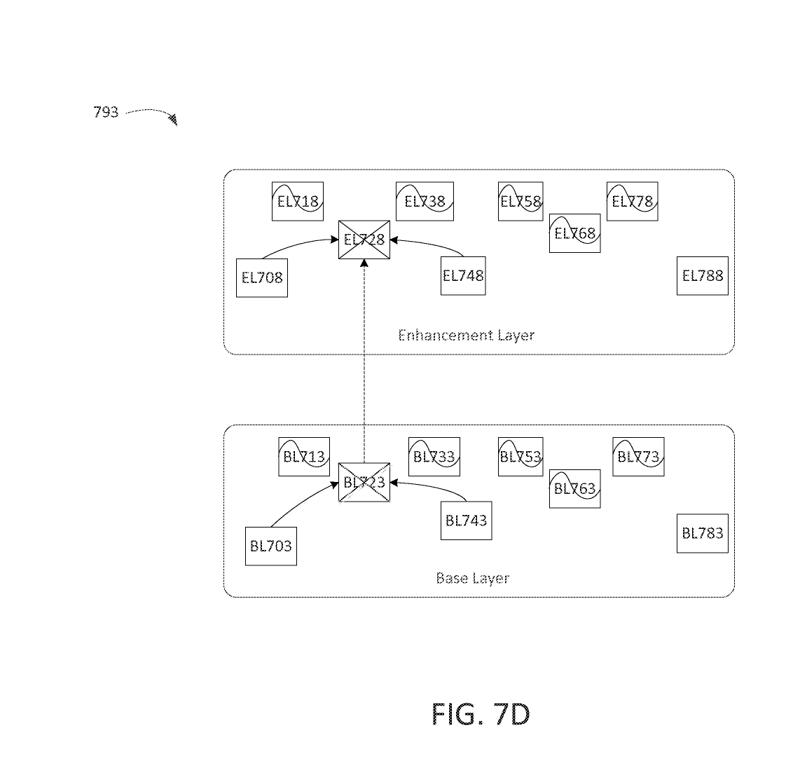

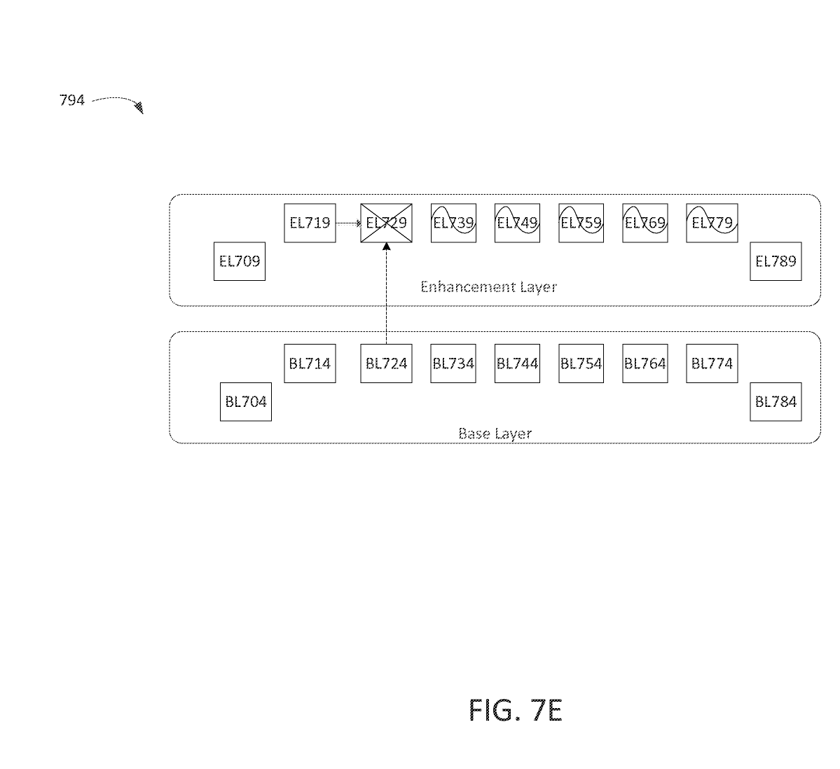

FIG. 6 is a diagram of an example of a picture reference relation with hierarchical B pictures. Picture reference arrangement 600 shows an example of the general hierarchical B pictures and their picture prediction relations. The pictures located in the lower temporal level may be referenced by the pictures in the higher temporal level. For example, if a picture is lost during transmission, a video coding device may be configured to replace and/or regenerate the lost picture using the reference picture(s). If scalable video coding is used, a video coding device may be configured to conceal the errors from the lost picture using the current and/or lower layer's reference picture(s), for example, as shown in FIG. 6. For example, POC 622 may be referenced by POC 662, POC 612, and/or POC 632, because the POC 622 may be in the reference picture list of POC 662 (e.g., the common test condition (CTC) HEVC and SHVC). The actual error propagation may affect the other following pictures in the same intra period (e.g., as shown in FIGS. 7A-E).

FIGS. 7A-E are diagrams of example cases of picture losses in a base layer (BL) and an enhancement layer (EL) of scalable video coding. FIG. 7A is an example of a non-referenced picture (EL735) lost within a hierarchical B structure in an EL. In an example picture sequence 790, a video decoding device may copy one or more of the pictures EL725, EL745, and/or BL730 for the lost EL735 as an EC solution. The video coding device may use Scalable HEVC Test Model (SEEM) EC. The video coding device using SUM EC may copy the nearest next picture in a reference list. For example, if the base quantization parameter (QP) value of the next picture (EL745) is lower than the one of the previous picture (EL725), the copied picture my have better peak signal-to-noise ratio PSNR.

FIG. 7B is an example of the referenced picture loss in an EL. In an example picture sequence 791, a video coding device may copy one or more, of EL706, EL746, and/or BL721 for the lost picture EL726. Because EL726 may be referenced by EL716, EL736, and/or EL766, losing EL726 may cause error propagation in EL716, EL736, EL756, EL766, and/or EL776 (e.g., which may be marked with a wave in FIG. 7B).

A scalable video coding structure may be used. In the example picture sequence 791, the video coding device may use picture copying for EC in single layer and/or base layer video coding, for example in MPEG-2 video, H.264 AVC, HEVC, and/or the like. For example, if the base layer depicted in FIG. 7B is encoded as a single layer bitstream, or as the base layer for a multi-layer bitstream, the video coding device may determine that BL701 and BL741 may be candidate pictures for picture copying when the BL721 picture is lost.

FIG. 7C is an example of referenced picture losses in the BL and the EL. The picture EL727 and the collocated picture BL722 may be lost. In the example picture sequence 792, a video coding device may copy BL702 and/or BL742 to make up the lost picture BL722. The video coding device may copy EL707, EL747, and/or the error concealed BL722 to make up the lost picture EL727. Because EL727 could be referenced by EL717, EL737, and/or EL767, losing EL727 may cause error propagation in EL717, EL737, EL757, EL767, and/or EL777.

FIG. 7D is an example of referenced picture losses in the BL and the EL where there are different GOP sizes for the BL and the EL. The GOPs of BL and EL may be eight and four, respectively. The base QP value of the EL may be the same as the other examples. In the example picture sequence 793, a video coding device may apply the delta QPs to pictures in a different temporal level, for example, according to a test condition of SHVC. The QP for picture EL748 in FIG. 7D) may be less than the QP for picture EL in FIG. 7C. The video coding device may select EL748 in FIG. 7D for EC.

FIG. 7E is a diagram of an example of picture loss with an I-P-P-P coded structure. If picture EL729 is lost, then picture EL719 and/or picture BL724 may be candidates for picture copy. In the example picture sequence 794, a video coding device may copy picture EL719 and/or picture BL724 to compensate for the lost picture EL729.

In the examples of FIGS. 7A-E, if a video coding device (e.g., a video decoding device) copies a picture that has a minimal disparity (e.g., sum of absolute difference (SAD)) for the missing picture, then the error propagation may be reduced. A video coding device may select the picture that has minimal disparity with the lost picture for video streaming over an error-prone network.

A video coding device may use EC modes for scalable video coding (SVC). For example, when a picture in an EL is damaged during transmission, a video coding device, such as a video decoding device, may use the picture in BL to make up the lost EL picture. For EC, a video coding device may apply upsampling using lower layer pictures. For EC, a video coding device may apply motion compensation using the same layer pictures. For example, a video coding device, such as a video decoding device, may prepare the upsampled lower layer picture at an Inter-Layer Picture (ILP) buffer. EC modes may utilize motion vector (MV), a coding unit (CU), and/or macro block (MB) level motion compensation and copying. EC modes include, but are not limited to, Picture Copy (PC), Temporal Direct TD), Motion Copy (MC), Base Layer Skip (BLSkip; Motion & Residual upsampling), and/or Reconstructed BL upsampling (RU).

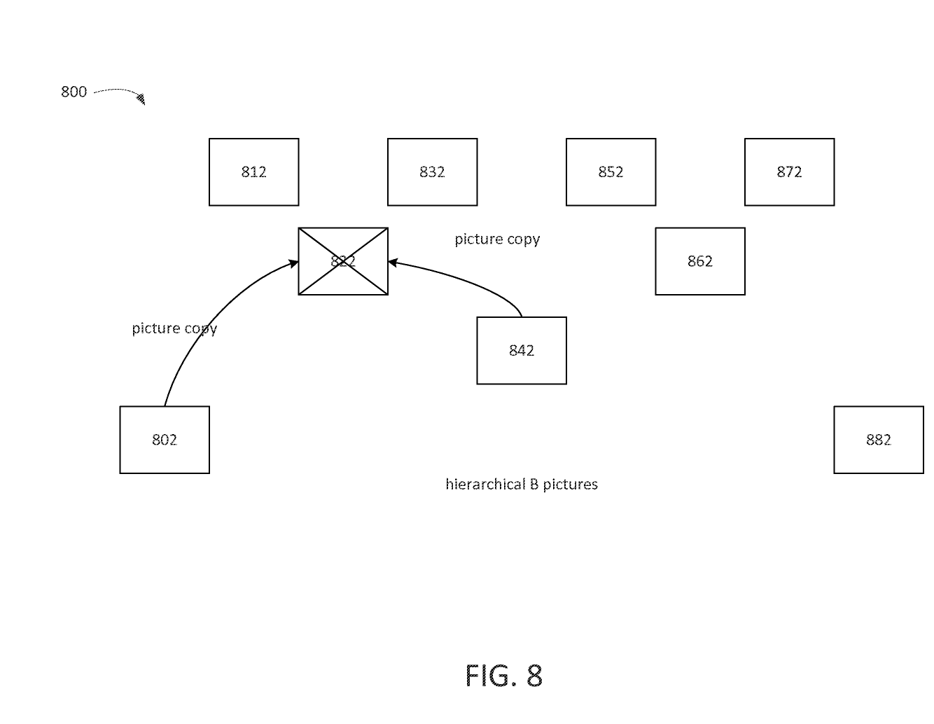

FIG. 8 is a diagram of an example of picture copy. In the example picture sequence 800, a video decoding device may be configured to utilize picture copy (PC) error concealment. In PC error concealment, a video coding device may copy a concealment picture from the picture 802 and/or from the picture 842 in a reference picture list (RPL).

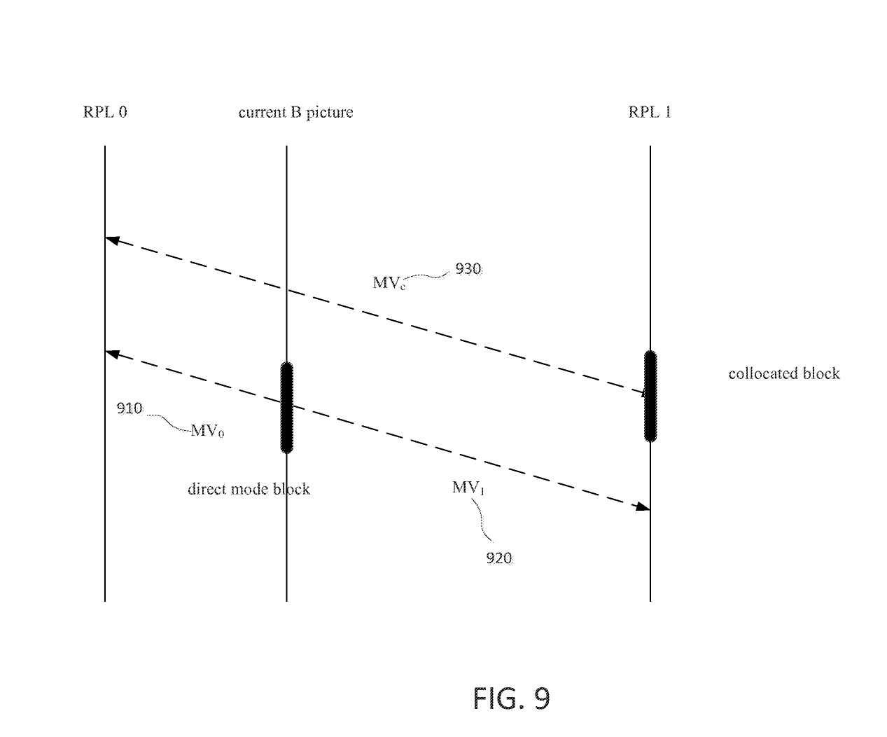

FIG. 9 is a diagram of an example of temporal direct for a B picture. A video coding device may utilize temporal direct (TD) error concealment for B pictures. TD (e.g., temporal direct MV generation) may be an intra layer EC mode. A coding unit (CU) (e.g., or MB) may receive and/or scale the MVs from a collocated CU (e.g., or MB) at the same layer, for example, as shown in FIG. 9. For example, the MV may be scaled according to the temporal distance of the pictures. For example, a video coding device may scale MV₀ 910 and MV₁ 920 from MVₑ 930 by using the picture order count (POC) differences (e.g., temporal distance). The video coding device may use TD for B pictures in a layer (e.g., each layer) of SVC.

A video coding device may utilize motion copy (MC) for error concealment. The video coding device may apply MC for pictures (e.g., I and/or P pictures), for example when TD error concealment is be applicable for the lost pictures. PC error concealment may not be efficient for the lost key picture, for example, due to the distance of two key pictures depending on GOP size. In MC error concealment, a video coding device may regenerate one or more MVs by copying the motion field of the previous key picture(s) to get a more accurately concealed picture for the lost picture. The video coding device may use MC to repair the loss of the base layer key picture. The video coding device may use MC to repair the loss of the pictures of the enhancement layer whose base layer pictures are lost.

A video coding device may utilize base layer skip (BLSkip; Motion & Residual upsampling) for error concealment. BLSkip may be an inter-layer EC mode. BLSkip may use residual upsampling and/or MV upscaling for a lost picture in the EL. For example, if a picture in the EL is lost, a video coding device may use residual upsampling to upsample the residual of the BL. The video coding device may conduct motion compensation at the EL using the upscaled motion fields.

A video coding device may utilize reconstructed BL upsampling (RU) for error concealment. In RU, a video coding device may unsample the reconstructed BL picture for the lost picture at the EL.

A video coding device may utilize BLSkip+TD for error concealment. If BL and EL pictures are lost at the same time, a video coding device may generate the MVs for the BL picture using TD. The video coding device may apply BLSkip for the lost picture in the EL.

Decoded video quality with EC may vary according to the characteristics of the video sequence, for example, such as bitrate, motion, scene change, brightness, etc. A video decoding device may be unable to select the best EC mode (e.g., the EC mode that provides minimal disparity) without the original picture (e.g., the unencoded picture, represented for example in a YUV format). The video decoding device may be unable to guarantee that a selected EC mode for a certain lost picture is the best possible selection (e.g., the EC mode that provides minimal disparity).

A video coding device may utilize E-ILR Mode 1. In E-ILR Mode 1, a video coding device may derive an enhanced inter-layer reference picture by adding motion compensated residuals with the upsampled BL picture, for example, as described in PCTUS2014/032904, the entirety of which is incorporated by referenced herein. For example, the E-ILR picture according to E-ILR Mode 1 may be formed by a video coding device and may be used for error concealment of a corresponding EL picture (e.g., by copying the E-ILR picture).

A video coding device may utilize E-ILR Mode 2. In E-ILR Mode 2, a video coding device may derive an enhanced inter-layer reference picture by high pass filtering an enhancement layer picture, low pass filtering a base layer picture and adding together the two resulting filtered pictures, for example, as described in PCT/US2014/57285, the entirety of which is incorporated by referenced herein. For example, the E-ILR picture according to E-ILR Mode 2 may be formed by a video coding device and may be used for error concealment of a corresponding EL picture (e.g., by copying the E-ILR picture).

A video coding device may use EC modes using PC to copy one or more of neighboring pictures for a lost picture, for example, as shown in Table 1. In case one EL picture is lost, the video coding device, such as a video decoding device shown in FIG. 4, may select one or more of the EC modes.

TABLE 1
Example of PC of EC

EL_prev: may copy the nearest previous picture that is referenced by
the lost picture in the EL.
EL_next: may copy the nearest next picture that is referenced by the
lost picture in the EL.
EL_lowQP: may copy the picture that has lowest QP among nearest

previous and/or next pictures that are referenced by the lost picture in the
EL.

BL_ups: may copy the upsampled reconstructed picture that is
collocated in the BL.

A video coding device, such as a video decoding device, may experience difficulty determining the EC mode (e.g., the EC mode that provides minimal disparity) among a plurality of EC modes without the video coding device having access to the original picture. A video coding device, such as a video encoder as shown in FIG. 3, may simulate various EC modes on a particular damaged picture (e.g., a picture which might be damaged in transit, for example, due to packet loss). The video coding device may determine the best EC mode (e.g., the EC mode that provides minimal disparity) to be used by a video decoding device in the event that a particular picture is damaged.

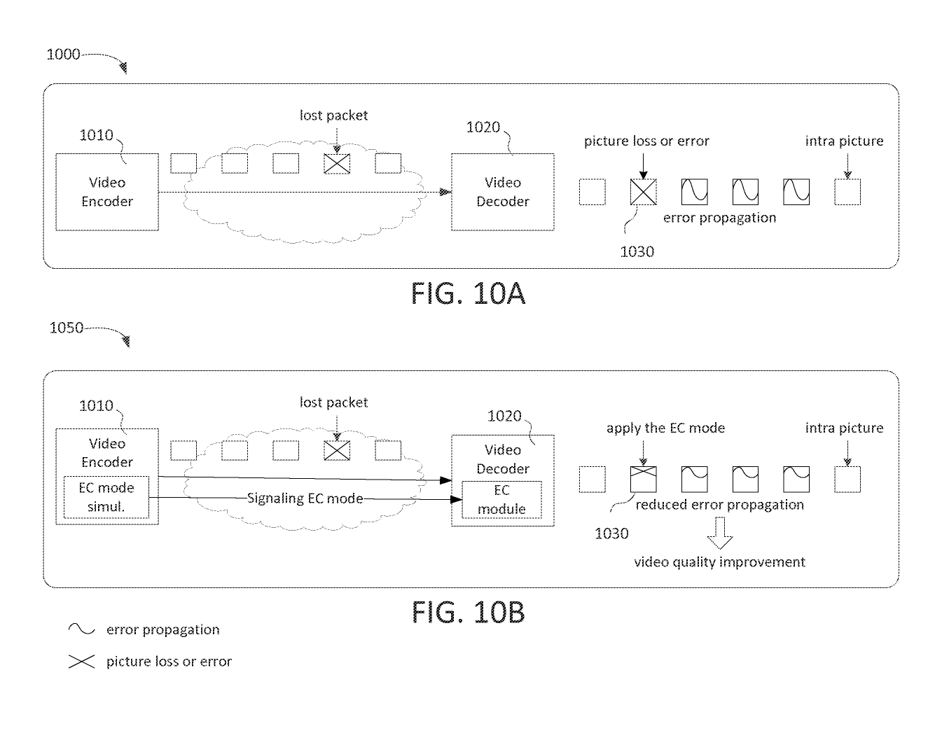

A video coding device may signal one or more error concealment (EC) modes for a video decoder. FIG. 10A is a diagram of an example of EC. FIG. 10B is a diagram of an example of EC mode signaling where a determined EC mode may be signaled by the video encoding device to the video decoding device. FIG. 1000 illustrates an example of the resulting error propagation when no EC mode is signaled in a video bitstream. FIG. 1050 illustrates an example of resulting error propagation when an EC mode is signaled in a video bitstream. As shown by 1000 and 1050, error propagation is reduced when an EC mode is signaled in a video bitstream.

A video coding device may use EC mode signaling to calculate the disparities between original input YUVs and reconstructed YUVs that are simulated with multiple EC modes (e.g., EC mode prediction). For example, a video encoding device 1010, as shown in FIG. 3, may select an EC mode (e.g., a best EC mode) among the calculated disparities. The video encoding device 1010 may select an EC mode that introduces the least amount of disparity as compared to the other tested EC modes. The selected EC mode may include, but is not limited to, one or more of the EC modes described herein. The video encoding device 1010 may signal the EC mode to a video decoding device 1020 in a client. For example, the video encoding device 1010 may transmit the EC mode to the video decoding device 1020 using a supplemental enhancement information (SEI) message, placing information in the packet header, using a separated protocol, and/or the like. The EC mode information may be delivered to the video decoding device 1020 using any means known to one skilled in the art.

Referring to FIG. 10, picture 1030 may be lost during the transmission of a video bitstream from a video encoding device 1010 to a video decoding device 1020. The video encoding device 1010 may determine an EC mode to use for the picture 1030, if lost. The encoding device 1010 may signal the selected EC mode to use for the picture 1030, if lost, in the video bitstream. The video decoding device 1020 may receive the video bitstream and determine that picture 1030 was lost during transmission. The video decoding device 1020 may apply the signaled EC mode to the lost picture 1030. Error propagation may be reduced by the video encoder 1010 signaling an EC mode to the video decoder 1020 and the video decoder 1020 applying the selected EC mode to lost pictures.

EC mode signaling may be performed on a layer basis. For example, an EC mode (e.g., one EC mode) may be determined and/or signaled by a video encoding device for each layer of a video stream. EC mode signaling may be performed on a picture-by-picture basis. For example, an EC mode may be determined and/or signaled by a video encoding device for one or more pictures (e.g., each picture) of a layer of a video stream.

A video coding device may receive a video input comprising a plurality of pictures. The video coding device may select a first picture from the plurality of pictures in the video input. The video coding device may evaluate two or more error concealment modes for the first picture. The error concealment modes may comprise at least two of Picture Copy (PC), Temporal Direct (TD), Motion Copy (MC), Base Layer Skip (BLSkip; Motion & Residual upsampling), Reconstructed BL upsampling (RU), E-ILR Mode 1, or E-ILR Mode 2.

The video coding device may select an error concealment mode from the two or more evaluated error concealment modes for the first picture. For example, the video coding device may select the error concealment mode based on a disparity between the first picture and an error concealed version of the first picture. The video coding device may select the error concealment mode having a smallest calculated disparity. For example, the disparity may be measured according to one or more of a sum of absolute differences (SAD) or a structural similarity (SSIM) between the first picture and the error concealed version of the first picture determined using the selected EC mode. The disparity may be measured using one or more color components of the first picture.

The video coding device may signal the selected error concealment mode for the first picture in a video bitstream. For example, the video coding device may signal the error concealment mode in a supplemental enhancement information (SEI) message of the video bitstream, an MPEG media transport (MMT) transport packet, or an MMT error concealment mode (ECM) message.

The video coding device may evaluate one or more error concealment modes for a second picture. The error concealment modes evaluated for the second picture may be the same as or different from the plurality of error concealment modes evaluated for the first picture. The video coding device may select an error concealment mode for the second picture. The video coding device may signal the selected error concealment mode for the second picture and the selected error concealment mode for the first picture in the video bitstream. The selected error concealment mode for the first picture may be the same as or different from the selected error concealment mode for the second picture.

A video coding device may receive a video bitstream comprising a plurality of pictures. The video coding device may receive an error concealment mode for a first picture in the video bitstream. The video coding device may determine that the first picture is lost. The video coding device may perform error concealment for the first picture. The error concealment may be performed using the received error concealment mode for the first picture (e.g., the error concealment mode that was determined by the video encoding device and signaled in the bitstream). The video coding device may receive an error concealment mode for a second picture in the video bitstream. The video coding device may determine that the second picture is lost. The video coding device may perform error concealment for the second picture. Error concealment may be performed using the received error concealment mode for the second picture. The error concealment mode for the second picture may be the same as or different from the error concealment mode for the first picture.

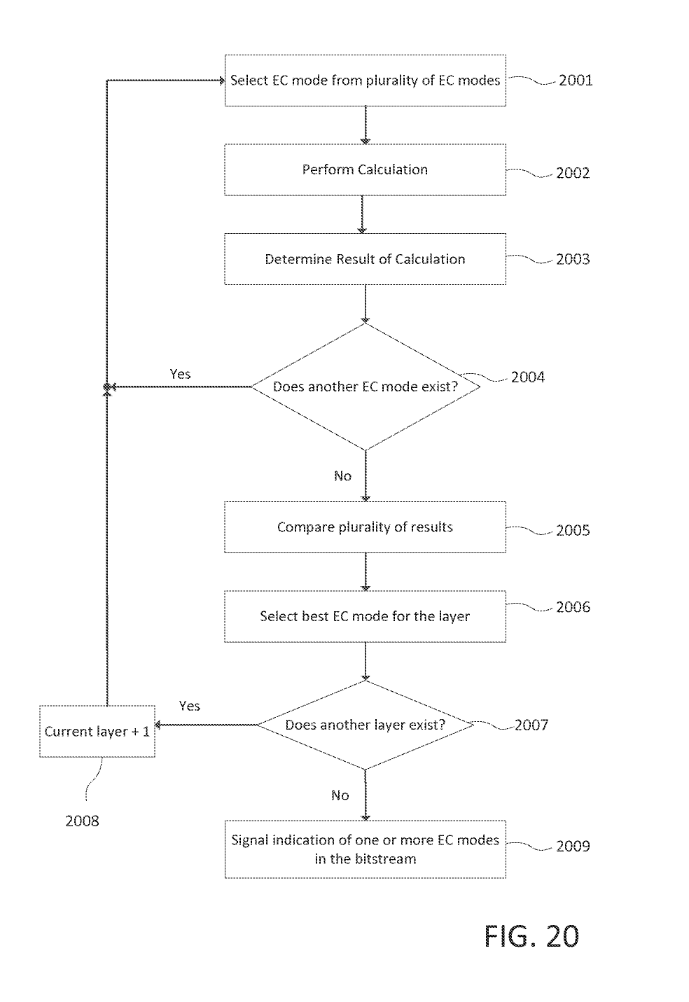

FIG. 20 is a diagram of example EC mode signaling that may be performed by a video coding device (e.g., a video encoding device). FIG. 20 may be applicable for EC mode signaling for a single layer Of scalable multilayer video. A video coding device may be configured to perform EC mode signaling at a layer level. For example, the video coding device may determine and/or signal an EC mode for one or more (e.g., each) layer of a video stream. At 2001, the video coding device may select an EC mode (e.g., a candidate EC mode) from a plurality of EC modes. The video coding device may evaluate two or more error concealment modes for each picture in the plurality of pictures. The EC modes may include, but are not limited to Picture Copy (PC), Temporal Direct (TD), Motion Copy (MC), Base Layer Skip (BLSkip; Motion & Residual upsampling), Reconstructed BL upsampling (RU), E-ILR Mode 1, and/or E-ILR Mode 2.

At 2002, the video coding device may be configured to perform a calculation based on the selected EC mode. For example, the video coding device may compare disparities among the application of the selected EC mode to one or more pictures of a layer of the input video stream. The video coding device may perform the calculation on multiple pictures, for example, depending on the EC modes available. The video coding device may select the EC mode that may provide the best picture quality when replacing the lost picture. The video coding device may determine which EC mode may provide the best picture quality by utilizing SAD, SSIM, etc. The video coding device may select the error concealment mode based on a disparity between the first picture and an error concealed version of the first picture. The video coding device may select the error concealment mode having the smallest calculated disparity. For example, the video coding device may select the error concealment mode based on a disparity between YUV components of a first picture and YUV components of a reconstructed version of the first picture. The video coding device may measure the disparity using a sum of absolute differences (SAD) or a structural similarity (SSIM) of the first picture and the error concealed version of the first picture determined using the selected EC mode. For example, the video coding device may measure the disparity according to a sum of absolute differences (SAD) or a structural similarity (SSIM) of the YUV components of the picture and the YUV components of the reconstructed version of the picture determined using the selected EC mode. The video coding device may measure the disparity using a SAD of the Y component only or a weighting sum of a SAD of the Y, U, and V components. The video coding device may select the error concealment mode having the smallest calculated disparity. The disparity may be measured using one or more color components of the first picture.

At 2003, the video coding device may determine the results of the calculation performed at 2002. For example, the video coding device may determine the performance value for one or more EC modes. The performance value for one or more EC mode may be based on the distortion between the original signal and the concealed signal using each EC mode. The distortion may be calculated using the Mean Squared Error, Sum of Absolute Difference, etc. At 2004, the video coding device may determine if another EC mode exists. If another EC mode exists, the video coding device may repeat 2001, 2002, 2003 and 2004. For example, the video coding device may perform 2001, 2002, 2003, and 2004 for each of the plurality of EC modes to determine the performance value of each of the plurality of EC modes. Although not limited to such, the plurality of EC modes may include one or more (e.g., any combination) of the EC modes described herein.

If another EC mode does not exist, at 2005, the video coding device may compare the plurality of performance values from 2003. The video coding device may compare the performance values determined at 2003. The video coding device may determine the best performance value (e.g., lowest distortion) for a layer and/or a picture. The EC mode may select the EC mode associated with the best performance value for the layer and/or the picture. The video coding device may divide the plurality of pictures into a first subset of pictures and a second subset of pictures. The video coding device may select an error concealment mode from the two or more evaluated error concealment modes for each picture in the plurality of pictures. The selected error concealment mode for the first subset of pictures may be the same and the selected error concealment mode for the second subset of pictures may be the same. The video coding device may signal the selected error concealment mode for the first subset of pictures and the selected error concealment mode for the second subset of pictures in the video bitstream. If multiple layers exist, the video coding device may select the same or a different EC mode for each picture.

At 2006, the video coding device may select the best EC mode for the layer and/or the picture from among the plurality of results. At 2007, the video coding device may determine if another layer exists. If another layer exists, at 2008, the video coding device may set the layer to be equal to the current layer plus one and repeat 2001, 2002, 2003, 2004, 2005, 2006, 2007 for the current layer plus one. The video coding device may determine that a higher layer of the video input exists. The higher layer may be higher than a layer comprising the first picture. The video coding device may select a picture from a plurality of pictures in the higher layer of the video input. The video coding device may evaluate two or more error concealment modes for the selected picture of the higher layer. The video coding device may select an error concealment mode from the two or more evaluated error concealment modes for the selected picture from the higher layer. The video coding device may signal the selected error concealment mode for the selected picture of the higher layer in the video bitstream with the error concealment mode for the first picture.

If another layer does not exist, at 2009, the video coding device may signal an indication of one or more EC modes in the video bitstream. Within each layer, a plurality of pictures may exist. A video coding device may evaluate two or more error concealment modes for a layer. The video coding device may select an error concealment mode from the two or more error concealment modes. The video coding device may signal the selected error concealment mode in a video bitstream for the layer. A video coding device may calculate the performance value of one or more layers by calculating and summing the performance value of each picture in the layer. Calculating and summing the performance value of each picture in the layer may cause delay at the video coding device. The video coding device may calculate the performance value of each layer based on the performance value of a selected subset of pictures in the layer. The video coding device may select the subset of pictures to be the first one or more (e.g., in the time domain) pictures in the layer. The video coding device may periodically update the performance value of the layer based on more recent pictures. The video coding device may select a new EC mode of the layer based on the updated performance result. The video coding device may signal an indication of the new EC mode in the bitstream.

A video coding device may receive a video input comprising a plurality of pictures. The video coding device may select a first picture from the plurality of pictures in the video input. The video coding device may evaluate two or more error concealment modes for the first picture. The video coding device may select an error concealment mode from the two or more evaluated error concealment modes for the first picture. The video coding device may signal the selected error concealment mode for the first picture in a video bitstream. The video coding device may select a second picture from the plurality of pictures in the video input. The video coding device may evaluate two or more error concealment modes for the second picture. The video coding device may select an error concealment mode from the two or more evaluated error concealment modes for the second picture. The video coding device may signal the selected error concealment mode for the second picture in the video bitstream. The selected error concealment mode for the first picture may be different from the selected error concealment mode for the second picture. The selected error concealment mode for the first picture may be the same as the selected error concealment mode for the second picture.

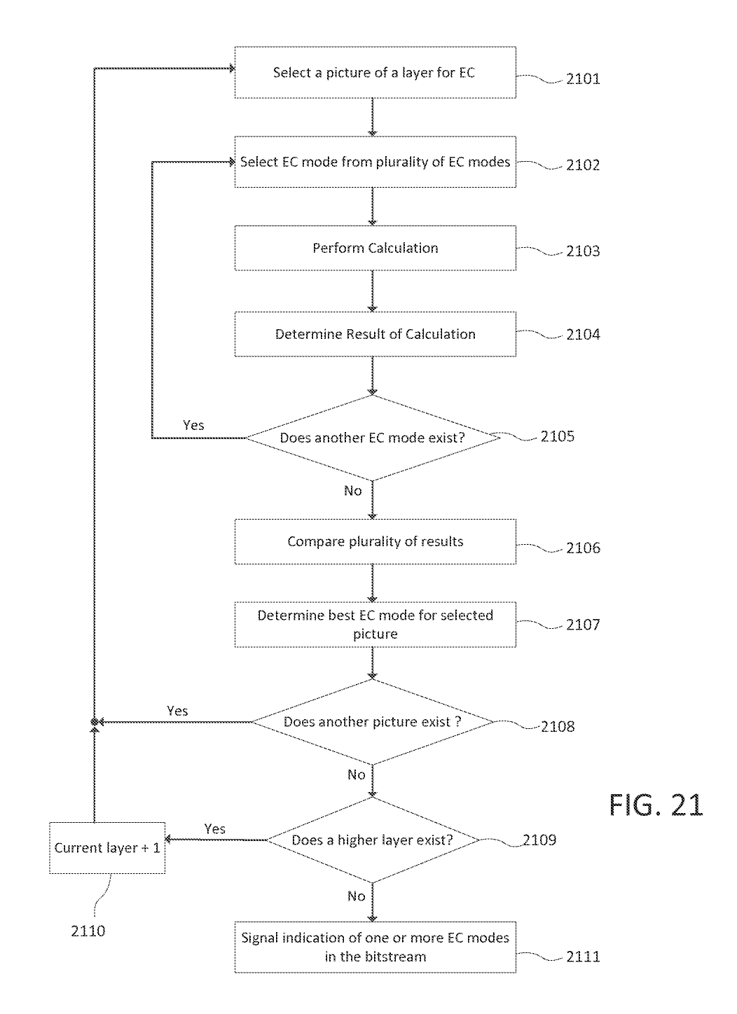

FIG. 21 is a diagram of example EC mode signaling. FIG. 21 may be applicable EC mode signaling for a single layer or scalable multilayer video bitstream. A video coding device may be configured to perform EC mode signaling at a picture level. For example, the video coding device may determine and/or signal an EC mode for one or more pictures (e.g., each picture) of one or more layers (e.g., each layer) of a video stream. At 2101, a video coding device may select a picture from a layer for EC. The EC modes may include, but are not limited to Picture Copy (PC), Temporal Direct (TD), Motion Copy (MC), Base Layer Skip (BLSkip; Motion & Residual upsampling), Reconstructed BL upsampling (RU), E-ILR Mode 1, and/or E-ILR Mode 2. At 2102, the video coding device may select an EC mode from a plurality of EC modes.

At 2103, the video coding device may be configured to perform a calculation. For example, at 2103, the video coding device may apply the EC mode to the selected picture from 2101. For example, the video coding device may compare disparities among the application of the selected EC mode to one or more pictures of a layer of the input video stream. The video coding device may select the error concealment mode based on a disparity between the first picture (e.g., the original first picture, or an encoded version of the first picture) and an error concealed version of the first picture. The video coding device may select the error concealment mode having the smallest calculated disparity. For example, the video coding device may select the error concealment mode based on a disparity between YUV components of a picture and YUV components of a reconstructed version of the first picture. The video coding device may measure the disparity using a sum of absolute differences (SAD) or a structural similarity (SSIM) of the first picture and the error concealed version of the first picture determined using the selected EC mode. For example, the video coding device may measure the disparity according to a sum of absolute differences (SAD) or a structural similarity (SSIM) of the YUV components of the picture and the YUV components of the reconstructed version of the picture determined using the selected EC mode. The video coding device may measure the disparity using a SAD of the Y component only or a weighting sum of a SAD of the Y, U, and V components. The video coding device may select the error concealment mode having the smallest calculated disparity.

At 2104, the video coding device may determine the results of the calculation performed at 2103. At 2105, the video coding device may determine if another EC mode exists. If another EC mode exists, the video coding device may repeat 2102, 2103, 2104 and 2105 for the plurality of EC modes. If another EC mode does not exist, at 2106, the video coding device may compare the plurality of results from 2104. At 2107, the video coding device may select the best EC mode for the selected picture from among the plurality of results. At 2108, the video coding device may determine if another picture exists. If another picture exists, the video coding device may repeat 2101, 2102, 2103, 2104, 2105, 2106, 2017 and 2108. If another picture does not exist at 2108, at 2109, the video coding device may determine if another layer exists. If another layer exists, at 2109, the video coding device may set the layer to equal the current layer plus one and repeat 2101, 2102, 2103, 2104, 2105, 2106, 2017, 2108 and 2109 for the current layer plus one. If another layer does not exist, at 2111, the video coding device may signal an indication of one or more EC modes in the video bitstream.

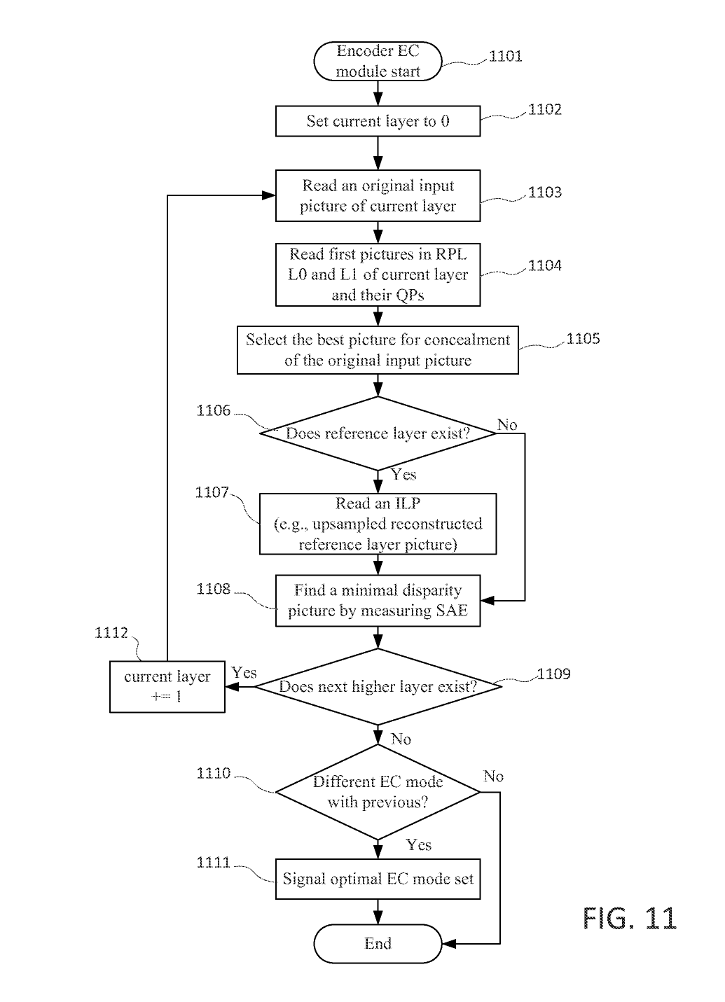

FIG. 11 is a diagram of example EC mode signaling from the perspective of a video encoding device. At 1101, a video encoding device may process EC mode signaling to provide EC mode information to a video coding device, such as a video decoding device. At 1101, the video coding device may begin the EC mode selection from the base layer (e.g., layer 0) in case multiple layers are available. At 1102, the video encoding device may set the current layer to 0, for example, to start from the lowest layer. At 1103, the video encoding device may read an original input picture of the current layer. At 1104, the video encoding device may read the first temporal reconstructed pictures from reference picture list L0, RPL0(0), and/or their QPs. At 1104, the video encoding device may read L1, RPL1(0), and/or their QPs. At 1104, the video encoding device may read a processed reconstructed reference layer (e.g., a lower layer) picture from the ILP.

At 1105, the video encoding device may select the best picture for concealment of the original input picture. For example, the video encoding device may compare the disparities among RPL0(0), RPL1(0) and/or ILP, for example, by measuring distortion such as Sum of Absolute Differences (SAD) and/or Structural Similarity (SSIM). The video encoding device may select the picture with the lowest disparity as the best picture for concealment. The video encoding device may use the SAD of Y component (e.g., only the SAD of the Y component) in the comparison at 1105. For example, the comparison may use a weighted sum of the SAD of the Y, U, and/or V components. For example, the video encoding device may compare the QP values used to encode the reconstructed pictures. The video encoding device may select the picture which has the lowest QP as the best picture for concealment.

At 1106, the video encoding device may determine if a reference layer exists. If a reference layer exists, at 1107, the video encoding device may read a processed reconstructed reference layer (e.g., a lower layer) picture from the ILP. If a reference layer does not exist, the video coding device may not read a processed reconstructed reference layer (e.g., a lower layer) picture from the ILP. If a reference layer is present or absent, at 1108, the video encoding device may select one or more pictures with the minimal disparity for EC. In 1108, the video encoding device may measure SAD to find a minimal disparity picture.

At 1109, the video encoding device may determine if a higher layer exists. If a higher layer exists, the video encoding device will repeat 1103, 1104, 1105, 1106, 1107 and 1108 for the higher layer. For example, if a dependent layer (e.g., a higher layer) is available, the video encoding device may increase the layer number and repeat 1103, 1104, 1105, 1106, 1107 and 1108. If a higher layer does not exist, the video encoding device may signal the selected/current EC mode (e.g., the EC modes for all layers) at 1111. The selected/current EC mode may include one or more EC modes. The selected/current EC mode may be a set of two or more EC modes. If a higher layer does not exist, at 1110, the video encoding device may determine if an EC mode different than a previous EC mode is present. At 1111, the video encoding device may signal the selected/current EC mode if the decided EC mode is different from a previous EC mode.

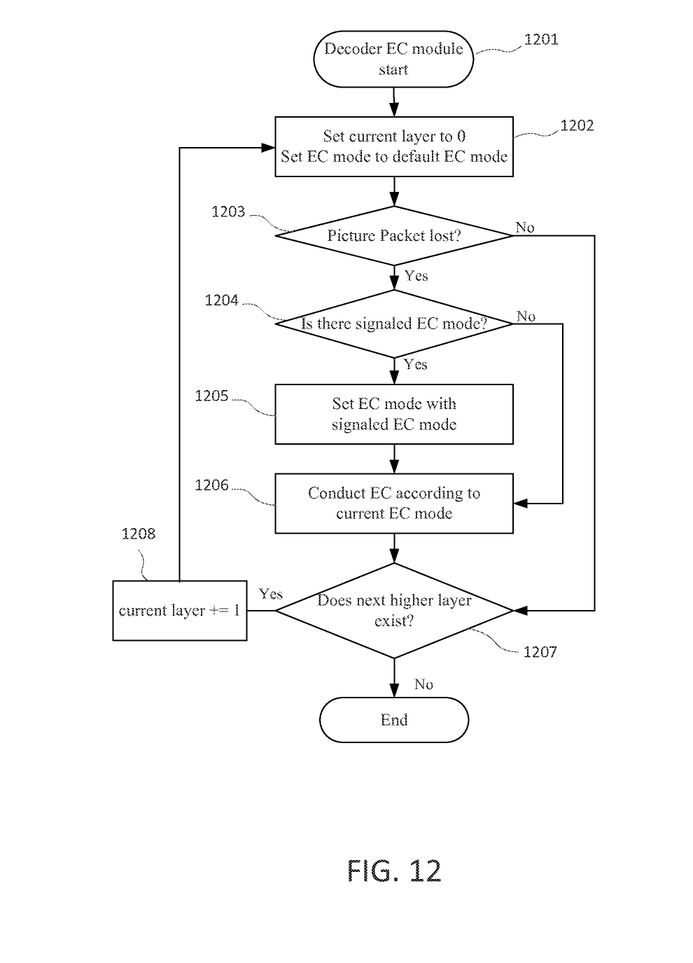

FIG. 12 is a diagram of example EC mode signaling from the perspective of a video decoding device. A video decoding device may process EC mode signaling. The video decoding device may receive a single layer or scalable multilayer video bitstream. At 1201, the video decoding device may begin EC module to determine the EC mode signaled. At 1201, the video decoding device may start EC mode processing. This may be performed while the bitstream is being decoded or after. At 1201, the video decoding device may read the signaled EC mode that was generated by the video encoding device.

At 1202, the video decoding device may set the current layer equal to 0, for example, so that the video decoding device may begin at the lowest layer. A video coding device may not fully decode a layer when the video coding device starts from that layer. If the lowest layer is not 0, the video decoding device at 1202 may set the current layer equal to the lowest layer. At 1202, the video decoding device may set the EC mode to the default EC mode. For example, if the video decoding device does not receive an EC mode signal and a picture is lost, the video decoding may apply the default EC mode to the lost picture. The default EC mode may be one of the EC modes described herein. The default EC mode may be one of Picture Copy (PC), Temporal Direct (TD), Motion Copy (MC), Base Layer Skip (BLSkip; Motion & Residual upsampling), Reconstructed BL upsampling (RU), E-ILR Mode 1, and/or E-ILR Mode 2.

At 1203, the video decoding device may determine if a picture was lost. If a picture was not lost, at 1207, the video decoding device may determine if a higher layer exists. If a higher layer exists, the video decoding device may go to 1203. If a picture was lost, the video decoding device may determine if an EC mode was signaled in the video bitstream at 1204. The EC mode may be applicable for the current layer (e.g., if layer based EC mode signaling is used) and/or the EC mode may be applicable for the current picture (e.g., if picture based EC mode signaling is used). If there is a signaled EC mode and if the picture was lost, at 1205, the video decoding device may set the EC mode with the signaled EC mode. The video decoding device may conduct EC (e.g., according to one of the EC modes described herein) according to the signaled EC mode at 1206. If no EC mode was signaled at 1204, the video decoding device may conduct EC according to the current EC mode (e.g., the default EC mode). At 1207, the video decoding device may determine if a higher layer exists. If a higher layer exists, the video decoding device may repeat one or more of 1203, 1204, 1205, 1206, 1207.

A video coding device may use error pattern files to evaluate performance of EC mode signaling. The error pattern files may have the number of lost POCs. A video coding device, such as a video decoding device as shown in FIG. 4, may conduct EC for the POCs.

Although described at the picture-level and for SVC, a video coding device may apply EC mode signaling at the slice-level and/or for single layer video coding.

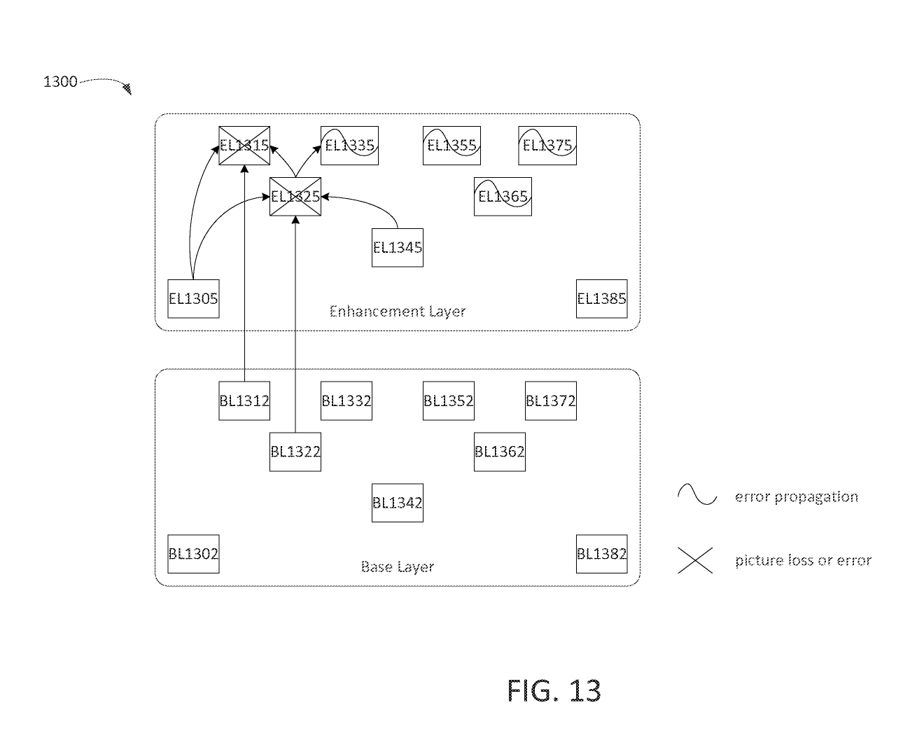

FIG. 13 is a diagram of an example of two consecutive pictures that are lost. A video coding device 1300, such as a video encoder as shown in FIG. 3, may simulate the multiple pictures lost, for example, as shown in FIG. 13. If the video encoding device 1300 has simulation and decides to copy EL1345 for the lost picture EL1325, then the video encoding device may simulate the EC mode for lost EL1315 with EL1305, BL1312, and/or EL1345 that replaced EL1325. The video encoding device 1300 may simulate the EC modes for the two consecutive pictures lost. The video encoding device 1300 may select a best combination of concealment modes and/or pictures to be used in the event that a combination of pictures are damaged or lost, and may signal the selected combination of concealment modes and/or pictures in the EC mode signaling. The video encoding device 1300 may be use the simulated EC modes for low delay configurations.

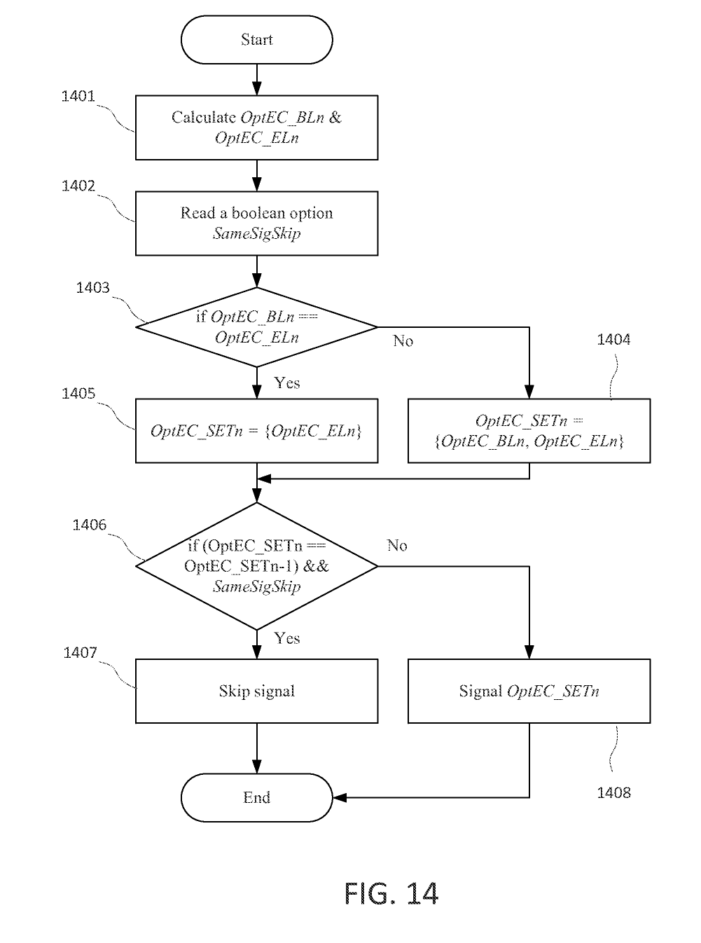

A video coding device may skip EC mode signaling. FIG. 14 is a diagram of an example of EC mode signaling. A video coding device, such as a video encoder as shown in FIG. 3, may signal the EC mode (e.g., the EC mode that provides minimal disparity) for lost BL and/or EL pictures (e.g., OptEC_SET: optimal EC mode for BL, optimal EC mode for EL) if the optimal EC modes for BL and/or EL are different from each other, for example, in the case of FIG. 7C and/or FIG. 7D. The optimal EC modes for BL and/or EL may be denoted as OptEC_BLn and OptEC_ELn, where n may be a POC number of current picture. At 1401, the video encoding device may calculate the optimal EC modes for BL and/or EL. At 1402, the video encoding device may read a Boolean option. The video encoding device may set the Boolean option, for example, if identical or similar EC mode signaling is shared by the current picture and the previous picture.

At 1403, if the two EC modes are different, the video encoding device may signal each mode at 1404. At 1403, if the two EC modes are the same, the video encoding device may signal one mode at 1405. If the selected EC mode of a current picture is the same as the EC mode of previous picture at 1406, then the video encoding device may not signal the optimal EC mode of current picture at 1407. Signaling overhead may be reduced if the video encoding device does not signal the optimal EC mode of the current picture. If the selected EC mode of a current picture is different from the EC mode of previous picture at 1406, then the video encoding device may signal the optimal EC mode of current picture at 1408. The video encoding device may change signaling according to packet loss rate (PLR) and/or target bitrate. For example, the video encoding device may use a Boolean flag (e.g., SameSigSkip, which means ‘skip same EC mode signaling’). Table 2 and FIG. 14 show an example of pseudo code and signaling of an EC mode with ‘skip same EC mode signaling’ when there are two layers (e.g., BL and EL).

TABLE 2
Example of pseudo code for signaling EC mode

read boolean SameSigSkip;
if (OptEC_BLn == OptEC_ELn)

then OptEC_SETn = OptEC_ELn;
else OptEC_SETn = {OptEC_BLn, OptEC_ELn};

if ((OptEC_SETn == OptEC_SETn-1) && (SameSigSkip == true) then
do not signal;
else signal

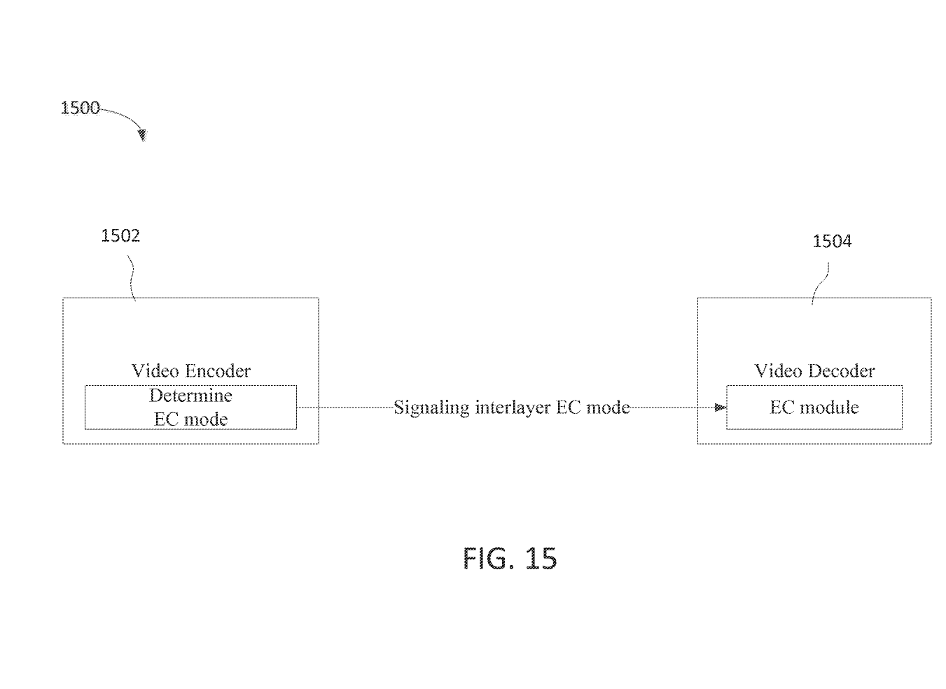

FIG. 15 is a diagram of an example EC mode signaling environment. FIG. 1500 illustrates an example of EC mode selection and signaling between a video encoder 1502 and a video decoder 1504. A video coding device, such as a video encoding device shown in FIG. 3 and/or a video decoding device shown in FIG. 4, may implement an optimal EC mode determination module in a video encoder and decoder (e.g., a modified SHM video encoder/decoder), for example, as shown in FIG. 15. A video encoder 1502 may determine an EC mode. An EC mode may be a Picture Copy (PC), Temporal Direct (TD), Motion Copy (MC), Base Layer Skip (BLSkip; Motion & Residual upsampling), Reconstructed BL upsampling (RU), E-ILR Mode 1, and/or E-ILR Mode 2. The video encoder 1502 may signal the determined EC mode to the video decoder 1504. The video decode 1504 may receive signals from the video encoder. The video decoder 1504 may comprise an EC module

Table 3 shows example implementations and test conditions.

TABLE 3
Example implementations and test condition

Added command line option for EC modes (EC0-EC4)

EC0 (EC mode 0): EL_prev.
EC1 (EC mode 1): EL_next
EC2 (EC mode 2): BL_ups.
EC3 (EC mode 3): EL_lowQP.
EC4 (EC mode 4): signaling optimal EC mode.

Picture dropping test for non-referenced pictures:

Implemented in a SHM encoder
Test sequence: BQ Terrace (1920 × 1080 and 1280 × 720), spatial
scalability 2× and 1.5× (two layers BL and EL).
Packet loss rate (PLR): 5% (final error rate: around 3.3% because
reference frames were not dropped).
Error patter: JVT error pattern file.
Non-referenced pictures in EL were dropped (e.g., as in FIG. 3A).

Picture dropping test for referenced pictures:

Implemented in SHM encoder and decoder.
Test sequence: Video conferencing test sequence A (1920 × 1080 and
1280 × 720), spatial scalability 2× and 1.5× (two layers BL and EL).
Packet loss rate (PLR): 5%
Error pattern: generated error pattern file.
Two pictures in 2^{nd} temporal level were dropped every 40 POCs
(=5% PLR) (e.g., as shown in FIG. 11).
Referenced pictures in EL were dropped (e.g., as in FIG. 3B),
for example, except pictures in lowest temporal level.
QP values (BL 38, EL 32, 33, 34) for spatial scalability 2× and 1.5×.
QP values (BL 38, EL 26, 28, 30) for SNR.

A video coding device, such as a video encoding device, (e.g., a SHM 2.0 encoder) may be modified to calculate an optimal EC mode. A video coding device, such as a video decoding device, (e.g., a SHM 2.0 decoder) may be modified to provide EC module. Table 4 shows an example of the modified encoder with its internal table. The video encoding device may calculate the average differences between the original YIN (Org.) and neighbored reference pictures (mode 0: previous picture (Picprev), mode 1: next picture (Picnext), mode 2: upsampled BL picture (PicBLup), etc.). The video encoding device may decide an optimal EC mode. The video encoding device may signal the optimal EC mode.

TABLE 4
Optimal EC Mode Calculation.

| | | | | Avg. Diff | Avg. Diff | Avg. Diff | Optimized |
|---|---|---|---|---|---|---|---|
| POC | QPₚᵣₑᵥ | QPₙₑₓₜ | QP_{BL} | \|Org. − Picₚᵣₑᵥ\| | \|Org. − Picₙₑₓₜ\| | (Org. − Pic_{BLup}) | EC mode |
| 0 | — | — | 38 | — | — | 105 | 2 |
| 8 | 32 | — | 39 | 0 | 1380 | 108 | 0 |
| 4 | 32 | 33 | 40 | 348 | 300 | 113 | 2 |
| 2 | 32 | 34 | 41 | 111 | 154 | 111 | 2 |
| 1 | 32 | 35 | 42 | 39 | 53 | 109 | 0 |
| 3 | 35 | 34 | 42 | 62 | 59 | 113 | 1 |
| 6 | 34 | 33 | 41 | 98 | 120 | 113 | 0 |
| 5 | 34 | 35 | 42 | 44 | 42 | 114 | 1 |
| 7 | 35 | 33 | 42 | 43 | 55 | 112 | 0 |
| 16 | — | — | 39 | — | — | 107 | 2 |

. . .

A video coding device may perform picture dropping tests for non-referenced and/or referenced pictures. Table 5 shows an example of PSNR gains between EC modes. In a test sequence, the maximum average PSNR gains of the proposed ED mode (e.g., EC4) may be between 4.94 dB to 8.60 dB in lost pictures, while minimum average Y-PNSR gains may be approximately 0.55 dB in 2× spatial scalability. Uniform picture copies from the EL (e.g., EC0, EC1, and EC3) may not have been optimal EC modes. The minimum gains were from EC mode 2 (EC2), and it was because upsampled collocated reconstructed BL pictures were mostly selected with minimal disparities.

Table 6 shows an example of average PSNR gain between EC modes. A video coding device may use a test sequence to test a video conferencing scenario. Because optimal EC modes on sequence A may have less number of EC mode2, the average PSNR gains may be greater than the gain in Table 5. The comparison of the proposed ED mode and EC mode 2 showed smaller numbers than Table 6. Because PLR 5% was applied to the test, averaging the PSNR gain may not provide an accurate comparison. The PSNR gain may be measured for the intraperiod and/or GOP that have lost pictures. Error propagations may be found and/or average Y-PSNR gain of 2× spatial scalability may be from 0.81 dB to 1.03 dB. While the PNSR values in Table 5 may be for non-referenced lost pictures, the PSNR values in Table 7 may be average number of intraperiod and GOP periods that have error propagation. The PSNR values in Table 7 may not be greater than the values in Table 5.

TABLE 5
Example of PSNR gain between EC modes for non-referenced pictures

| | | | | | | | Fixed EC | | Fixed EC | | | | | | |
|---|---|---|---|---|---|---|---|---|---|---|---|---|---|---|---|
| | | | | | | | (PC from | | (PC from | | | Max. | | | |
| | | | | | | | EL) | | BL) | | | Gain | | Min. Gain | |
| | Spatial | | | | Optimized EC | | | Only | | Only | | | Only | | Only |
| | scalability | BL QP | EL QP | Original | All | Only Lost | All | Lost | All | Lost | Lost Pics | All | lost | All | Lost |
| BQ Terrace | 2x | 26 | 24 | | 36.06 | 28.37 | 35.89 | 23.05 | 36.04 | 27.82 | 20/600 | 0.18 | 5.32 | 0.02 | 0.55 |
| 1920 × 1080@60 | | | 26 | | 35.34 | 28.37 | 35.16 | 23.11 | 35.32 | 27.82 | 20/600 | 0.18 | 5.27 | 0.02 | 0.55 |
| | | | 28 | | 34.82 | 28.37 | 34.64 | 23.15 | 34.80 | 27.82 | 20/600 | 0.17 | 5.22 | 0.02 | 0.55 |
| | | | 30 | | 34.28 | 28.35 | 34.11 | 23.17 | 34.27 | 27.82 | 20/600 | 0.17 | 5.18 | 0.02 | 0.53 |
| | | 30 | 28 | | 34.81 | 28.20 | 34.64 | 23.15 | 34.79 | 27.62 | 20/600 | 0.17 | 5.05 | 0.02 | 0.57 |
| | | | 30 | | 34.28 | 28.18 | 34.11 | 23.17 | 34.26 | 27.62 | 20/600 | 0.17 | 5.01 | 0.02 | 0.56 |
| | | | 32 | | 33.66 | 28.15 | 33.49 | 23.18 | 33.54 | 27.62 | 20/600 | 0.17 | 4.97 | 0.02 | 0.53 |
| | | | 34 | | 32.96 | 28.12 | 32.80 | 23.17 | 32.94 | 27.62 | 20/600 | 0.16 | 4.94 | 0.02 | 0.49 |
| | 1.5x | 26 | 24 | | 36.20 | 32.55 | 35.88 | 23.05 | 36.20 | 32.54 | 20/600 | 0.32 | 9.49 | 0.00 | 0.01 |
| | | | 26 | | 35.47 | 32.55 | 35.15 | 23.11 | 35.47 | 32.54 | 20/600 | 0.31 | 9.43 | 0.00 | 0.01 |
| | | | 28 | | 34.92 | 32.54 | 34.61 | 23.16 | 34.92 | 32.54 | 20/600 | 0.31 | 9.38 | 0.00 | 0.00 |
| | | | 30 | | 34.46 | 32.54 | 34.15 | 23.19 | 34.46 | 32.54 | 20/600 | 0.31 | 9.35 | 0.00 | 0.00 |
| | | 30 | 28 | | 34.92 | 31.84 | 34.63 | 23.15 | 34.92 | 31.80 | 20/600 | 0.29 | 8.69 | 0.00 | 0.03 |
| | | | 30 | | 34.37 | 31.83 | 34.08 | 23.18 | 34.37 | 31.80 | 20/600 | 0.29 | 8.65 | 0.00 | 0.03 |
| | | | 32 | | 33.72 | 31.82 | 33.43 | 23.19 | 33.72 | 31.80 | 20/600 | 0.29 | 8.62 | 0.00 | 0.01 |
| | | | 34 | | 33.13 | 31.80 | 32.85 | 23.20 | 33.13 | 31.80 | 20/600 | 0.29 | 8.60 | 0.00 | 0.00 |

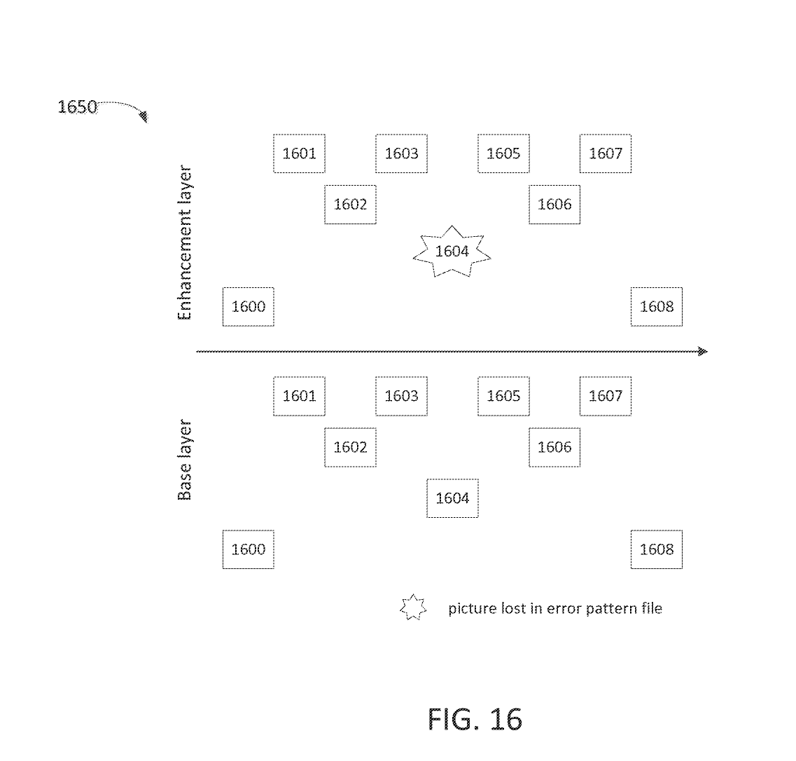

FIG. 16 is a diagram of an example of error pattern file generation. FIG. 1650 illustrates a picture 1604 lost in an error pattern file. As shown in 1650, picture 1604 is present in the base layer. Picture 1604 is lost in the enhancement layer. Using a test sequence, a video coding device may generate an error pattern file. In the error pattern file, two pictures located in the second temporal level (e.g., POC 4) may be dropped every 40 pictures, and the PLR may be about 4% (e.g., as in FIG. 16).

Table 6 shows an example of an average Y-PSNR gain between EC modes for referenced pictures (e.g., except EC mode 2). The average quality improvement may be approximately 2 dB in PSNR.

TABLE 6
Example of an average PSNR gain between EC
modes for referenced pictures (Sequence A)

| | QP | Avg. PSNR gain (dB) | | |
|---|---|---|---|---|
| Scalability | BL 38 | EC4-EC0 | EC4-EC1 | EC4-EC3 |
| 2× | EL 32 | 1.83 | 1.98 | 1.79 |
| | EL 33 | 1.77 | 1.91 | 1.74 |
| | EL 34 | 1.77 | 1.74 | 1.72 |
| 1.5× | EL 32 | 1.91 | 2.10 | 0.20 |
| | EL 33 | 1.91 | 1.89 | 1.87 |
| | EL 34 | 1.86 | 1.89 | 1.82 |
| SNR | EL 26 | 2.38 | 2.50 | 2.34 |
| | EL 28 | 2.29 | 2.45 | 2.26 |
| | EL 30 | 2.22 | 2.33 | 2.18 |

TABLE 7
Example of PSNR gain between EC4 and EC2 (sequence A.)

| | | | | PSNR gain (dB) | |
|---|---|---|---|---|---|
| | | OP | | Intraperiod | GOP |
| | Scalability | BL | EL | (POC 65-96) | (65-72) |
| Proposed EC | 2× | 38 | 32 | 0.64 | 1.03 |
| mode | | | 33 | 0.58 | 0.83 |
| v.s. | | | 34 | 0.47 | 0.81 |
| CP from BL | 1.5× | 38 | 32 | 0.26 | 0.38 |
| only | | | 33 | 0.22 | 0.35 |
| (EC 2 v.s. | | | 34 | 0.18 | 0.27 |
| EC4) | SNR | 38 | 26 | 0.33 | 0.37 |
| | | | 28 | 0.33 | 0.34 |
| | | | 30 | 0.14 | 0.20 |

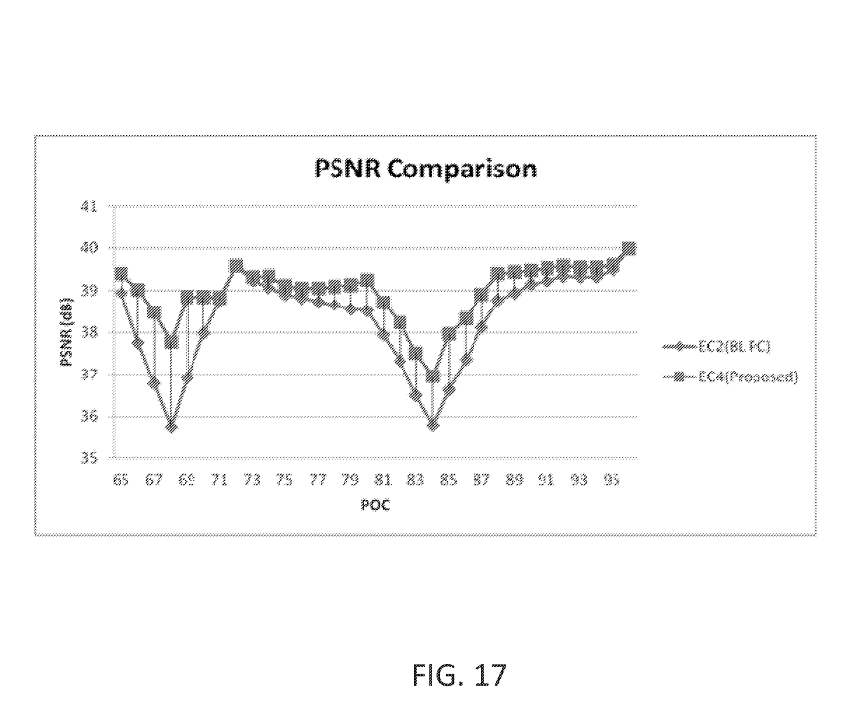

FIG. 17 is a diagram of an example PSNR comparison between EC mode 2 and EC mode 4. In the example, POC 68 and POC 84 may be dropped according to the error pattern file. As shown in FIG. 17, the proposed EC modes (e.g., EC mode 4; EC4) may show better PSNRs compared to the EC mode 2 when POC 68 and POC 84 were dropped. Because referenced pictures were dropped this time, there was error propagation, which may have degraded the following picture qualities. Table 7 provides an example of PSNR gain between EC4 and EC2.

A video coding device may utilize EC mode signaling to enhance video quality, for example, when a video coding device transmits multimedia data over an error-prone network. A video coding device may signal a proposed EC mode between a multimedia server and a client (e.g., a WTRU). For example, an SEI message that may be defined in a video standard (e.g., AVC, SVC, HEVC, and SHVC) may carry the EC mode. The video coding device may signal the EC mode using MMT packet header and/or MMT message protocol. The video coding device may signal the selected POC number(s) and/or delta POC number(s) (e.g., current POC-selected POC for PC).

A video coding device may use an SEI message to signal an EC mode (e.g., in HEVC, SHVC, and/or the like). A video coding device may provide QoS information (e.g., EC_mode) using an SEI message (e.g., a new SEI message). A video coding device may set the EC mode to an SEI message, for example, as shown in Table 8, Table 9, and/or Table 10. A video coding device may add the EC_mode in SEI payload syntax. The SEI type number (e.g., 140) may be changed, for example, according to the standard. The video coding device may use SEI message-based EC mode signaling to provide a general communication channel between a multimedia server and a client. An EC mode that is developed by application developer may use a user defined EC mode. For example, in Table 10, EC modes from 9 to 15 may be used for user defined EC mode. A video coding device may implement an EC mode for the service. A video coding device may define the EC mode in the user defined EC mode.

TABLE 8
Example of an SEI payload syntax

Descriptor

sei_payload( payloadType, payloadSize )
{

if( payloadType = = 0 )

...........

else if( payloadType = = 140)

QoS_info( payloadSize )

...........

TABLE 9
Example of a definition of a QoS_info for SEI

Descriptor

QoS_info (payloadSize ) {

| | |
|---|---|
| priority_id | u(4) |
| EC_mode | u(4) |

}

TABLE 10
Example of a definition of an EC
mode Table for Audio and/or Video

| EC mode (4- | | |
|---|---|---|
| bit) | EC mode | Note |
| 0 | Picture Copy from RPL0 (0) | Video |
| 1 | Picture Copy from RPL1 (0) | Video |
| 2 | Temporal Direct | Video |
| 3 | Motion Copy | Video |
| 4 | Base Layer Skip (BLSkip; Motion & Residual | Video |
| | upsampling) | |
| 5 | Reconstructed BL Upsampling | Video |
| 6 | Zero Fill | Audio |
| 7 | Frame Repetition | Audio |
| 8 | General SAS (sinusoidal analysis and synthesis) | Audio |
| 9-15 | User Defined | |

A video coding device may signal an EC mode using a MPEG Media Transport (MMT). A video coding device may provide the QoS information (EC_mode) using syntax (e.g., a new syntax) of a MMT transport packet. A video coding device may set an EC mode to a MMT transport packet, for example, as shown in Table 11. A video coding device may add an EC_mode in the MMT_packet syntax, for example, as shown in Table 11. A video coding device may change the syntax position.

TABLE 11
Example of MMT Transport Packet syntax

| | | |
|---|---|---|
| | No. | |
| | of | |
| Syntax | bits | Mnemonic |

MMT_packet ( ){

| | | |
|---|---|---|
| sequence number | | uimsbf |
| Timestamp | | uimsbf |
| RAP_flag | 1 | uimsbf |
| header_extension_flag | 1 | uimsbf |
| padding_flag | 1 | uimsbf |
| service_classifier ( ) { | | |

| | | |
|---|---|---|
| service_type | 4 | bslbf |
| type_of_bitrate | 3 | bslbf |
| Throughput | 1 | bslbf |

}
QoS_classifier ( ) {

| | | |
|---|---|---|
| delay_sensitivity | 3 | bslbf |
| reliability_flag | 1 | bslbf |
| EC_mode | 4 | bslbf |

}
flow_identifier ( ) {

| | 7 | bslbf |
|---|---|---|
| extension_flag | 1 | bslbf |

}
T.B.D.
If (header_extension_flag ==’1’)
{

MMT_packet_extension_header( )

}
MMT_payload ( )

}

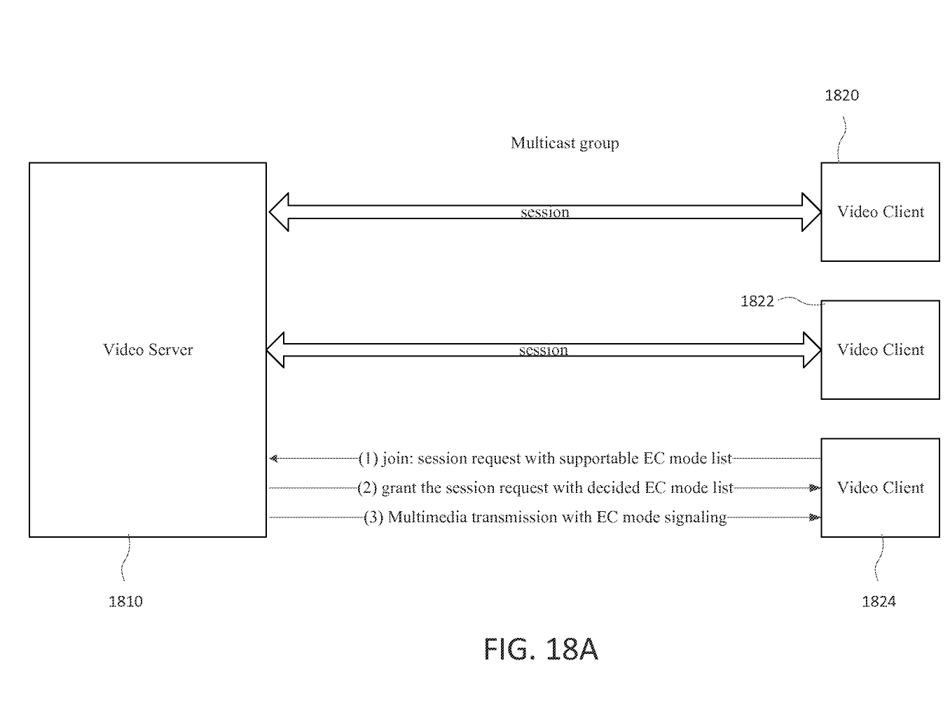

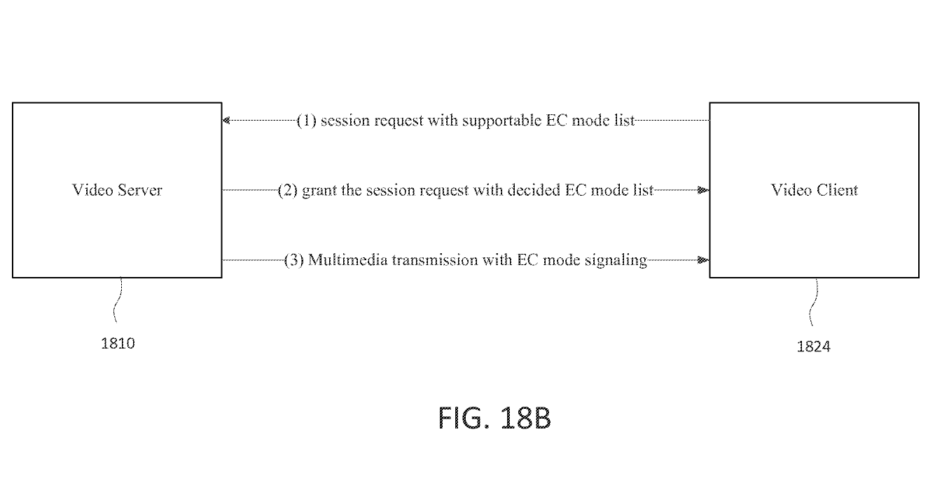

A video coding device may signal an EC mode using an MMT error concealment mode (ECM) message. FIG. 18A is a diagram of an example of a multicast group with supportable EC modes. FIG. 18B is a diagram of an example session initiation with supportable EC modes. A video coding device may signal an EC mode between a multimedia server 1810 and a client 1820/1822/1824 using a message that is defined by a multimedia system (e.g., MPEG-4 system, MPEG-H system MMT, and/or the like). For example, the server 1810 and client 1820/1822/1824 may exchange the information of supportable EC modes (e.g., EC mode candidates). The client 1820/1822/1824 may request multimedia service with the list of EC modes that the client 1820/1822/1824 can support, for example, at the session initiate time. The server 1810 may decide the supportable EC mode among the received list. If the server 1810 is multicasting media content to one or more subscribed clients, the server 1810 may select the shared EC mode(s) between those clients 1820/1822/1824. If the server 1810 is unicasting media content to one client 1824, then the server may select the EC modes (e.g., the EC modes that provides minimal disparity), for example according to its computational complexity of EC mode prediction (e.g., as shown in FIG. 18A and/or FIG. 18B). If the server 1810 is broadcasting media content, the server 1810 may generate multiple recommended EC modes with different priorities. For example, if the server 1810 generates the EC mode as a prioritized list of EC modes such as {2, 3, 1}, the generated EC mode may indicate that a client 1824 may use EC mode 2 first when a client 1824 supports the mode. If the client 1824 does not support the EC mode 2, the prioritized list of EC modes generated by server 1810 may indicate to the client 1824 to use EC mode 3, and/or EC mode 1.

If the server 1810 transmits pre-encoded video to the client 1824, the server 1810 may transmit EC modes (e.g., all EC modes) of entire pictures to the client 1824 in advance at the session initiation time. The server 1810 may transmit the EC modes of multiple pictures with different timing resolution (e.g., per every GOP, intra period, and/or the like).

A video coding device may use Session Initiate Protocol (SIP) with Session Description Protocol (SDP) for the handshaking process. The current media description of SDP may include a media name and/or transport address, a media title, connection information, bandwidth information, encryption key, and/or the like. A video coding device may carry the EC mode candidates over the current SDP and/or the extended SDP. The SDP may be extended, or example, as shown in Table 12.

TABLE 12
Example of an extension of SDP defined in IETF.

A parameter type (e.g., a new parameter type “ecm=”) may be used by
a video coding device to specify the error concealment mode (ECM) for
multimedia decoder at remote side.
For example, the “a = ecm:2” line may specify the error concealment
mode (ECM) with a value 2, and it may mean that the video decoding
device would use EC mode 2 until it receives next EC mode.

A video coding device may carry the EC mode candidates over a SIP-like protocol (e.g., a new SIP-like protocol), for example, in addition to the SDP.

The server may transmit one or more EC modes to the client, for example, after the handshaking process. A video coding device may use an ECM message (e.g., a new ECM message).

A video coding device may use an MMT ECM message to provide EC mode information for a MMT receiving entity (e.g., a decoder at a client). A video coding device may assign the value of the message identifier (e.g., message_id), for example, as shown in Table 13. The video coding device may define the syntax of semantics of the EC message, for example, as shown in Table 14.

TABLE 13
Example of message identifier (e.g., message_id) values

| Value | Description |
|---|---|
| 0x0000~0x00FF | reserved |
| 0x0100 | PA messages |
| 0x0500~0x44FF | MCI messages. |
| | For a package, 16 contiguous values |
| | are allocated to MCI messages, |
| | If the value %16 equals 15, the MCI |
| | message carries complete CL |
| | If the value %16 equals N where |
| | N = 0~1.4, the MCI message carries |
| | Subset-N CI. |
| 0x2500~0x84FF | MPT messages. |
| | For a package, 16 contiguous values |
| | are allocated to MPT messages. |
| | If the value %16 equals 15, |
| | the MPT message carries complete MPT. |
| | If the value %16 equals N where |
| | N = 0~14, the MPT message carries |
| | Subset-N MPT. |
| 0x4500 | CRI messages |
| 0x4900 | DCI messages |
| 0x5500 | MC messages |
| 0x5900 | AL_FEC messages |
| 0x6500 | HRBM messages |
| 0x6900 | RQF messages |
| 0x7500 | ECM messages |
| 0x8D00~0xFFFF | reserved |

TABLE 14
Example of ECM message syntax

| | | | |
|---|---|---|---|
| | | No. | |
| | | of | |
| Syntax | Values | bits | Mnemonic |

ECM_message ( ) {

| | |
|---|---|
| message_id | 16 |
| version | 8 |
| length | 32 |
| message_payload{ | |

| | | |
|---|---|---|
| packet_id | 8 | unsigned char |

| | | | |
|---|---|---|---|
| number of frames | N1 | 8 | unsigned char |
| number of streams | N2 | 8 | unsigned char |
| for (i=0; i<N1;i++) { | | | |

for(j=0;j<N2;j++) {

| | | |
|---|---|---|
| ec_mode | 8 | unsigned char |

}

| | |
|---|---|
| } | |
| reserved | 8 |

}

message_id may indicate the ID of an ECM message. The length of this field may be 16 bits.

version may indicate the version of an ECM message. The length of this field may be 8 bits.

length may indicate the length of the ECM message counted in bytes starting from the next field to the last byte of the ECM message. The value ‘0’ not be valid for this field. The length of this field may be 32 bits.

packet_id may indicate a packet_id in a MMT packet header.

number of frames may indicate the number of video and/or audio frames in the packet that has the packet_id.

number of streams may indicate the number of streams of video and/or audio. For a video stream, a video coding device may use number of streams to indicate the number of scalable layers for scalable video coding. For an audio stream, a video coding device may use number of streams to indicate the number of audio channels. For example, if the number of video pictures is ‘0’, the value of the number of layers may be ‘0’.

ec_mode may indicate an error concealment (EC) mode. A video coding device may use ec_mode to inform the video and/or audio decoding device of the EC mode to conceal lost pictures and/or audio chunks. A video and/or audio decoding device may use the EC mode until next ECM message has arrived.

reserved may indicate the reserved 8 bits for future use. For example, a video or audio coding device may add last_ec_mode here. A video and/or audio coding device may use last_ec_mode to indicate the ec_mode to use until next ECM message arrives.

A video coding device may use MPEG Green to signal an EC mode. A video coding device may use EC mode signaling to enhance the video transmission over an error prone environment. A video coding device may use EC mode signaling MPEG Green, for example, to reduce the device power consumption under certain circumstance, while maintaining the perceived video quality.

A client supporting Multimedia Telephony Service for IP Multimedia Subsystem (MTSI) and/or Multimedia Messaging Service (MMS) may receive EC mode signaling. A video coding device may skip certain video pictures at the encoder side to offload the computational workload of the video encoding device, for example, to reduce the power consumption (e.g., at the encoder and/or the decoder). Skipping picture(s) may cause quality degradation at the receiver side. A video decoding device may randomly copy a previously decoded picture to compensate for a skipped picture. A video coding device may use EC mode signaling (e.g., as specified in Table 10) to indicate which particular reference picture the video decoding device may use to reconstruct a skipped picture. A video decoding device may bypass the decoding process for non-reference pictures and apply EC mode signaled by the encoder to save power, for example, if the battery at client side is low in streaming applications. A video coding device may use the EC mode signaling as a normative green metadata, for example, along with the parameters such as the maximum pixel intensity in the frame, the saturation parameter, power saving request, etc., which may be included in MPEG Green.

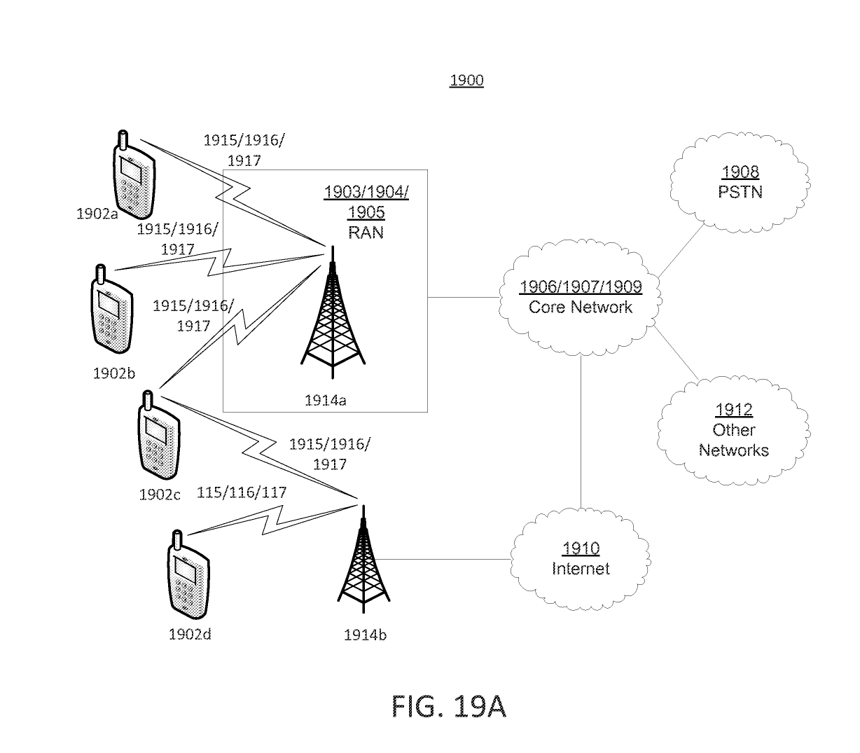

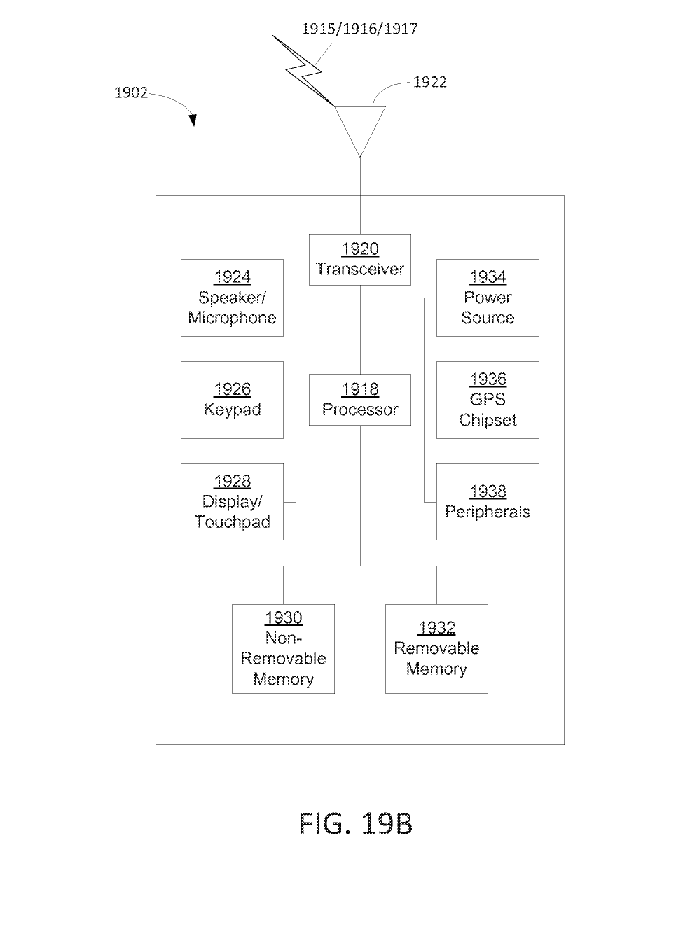

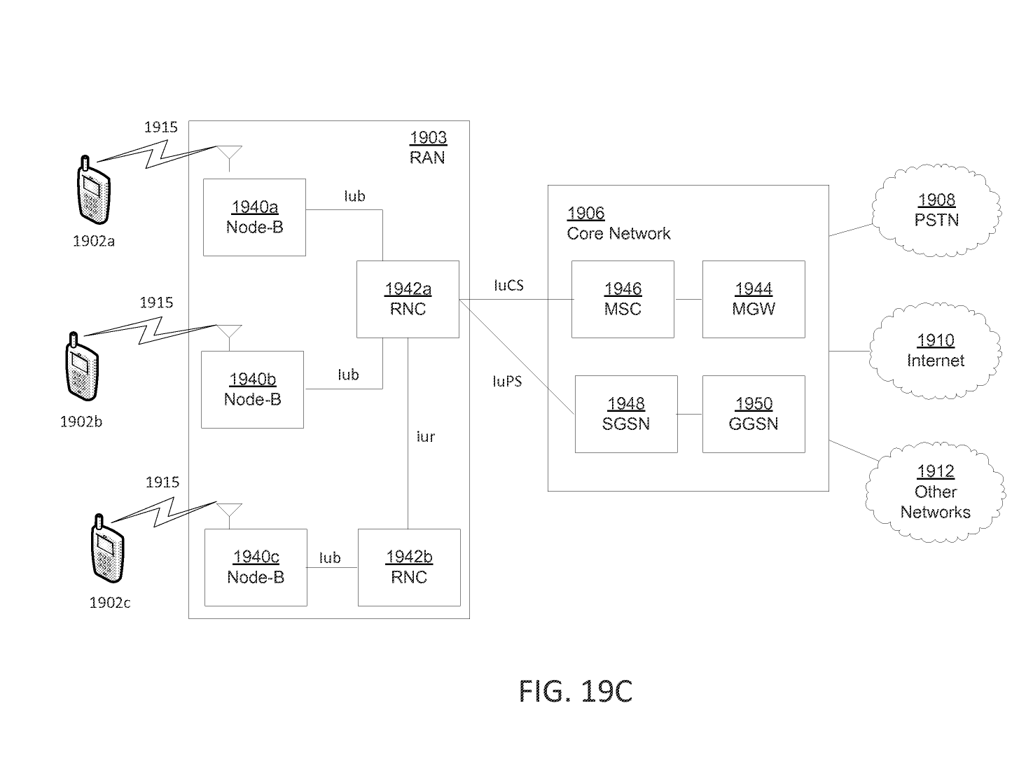

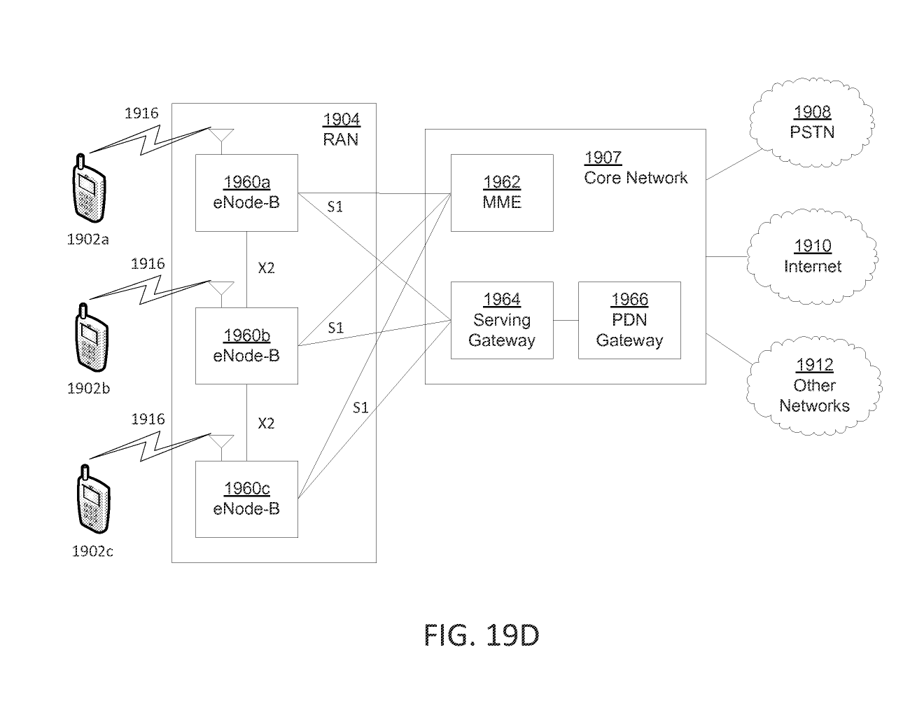

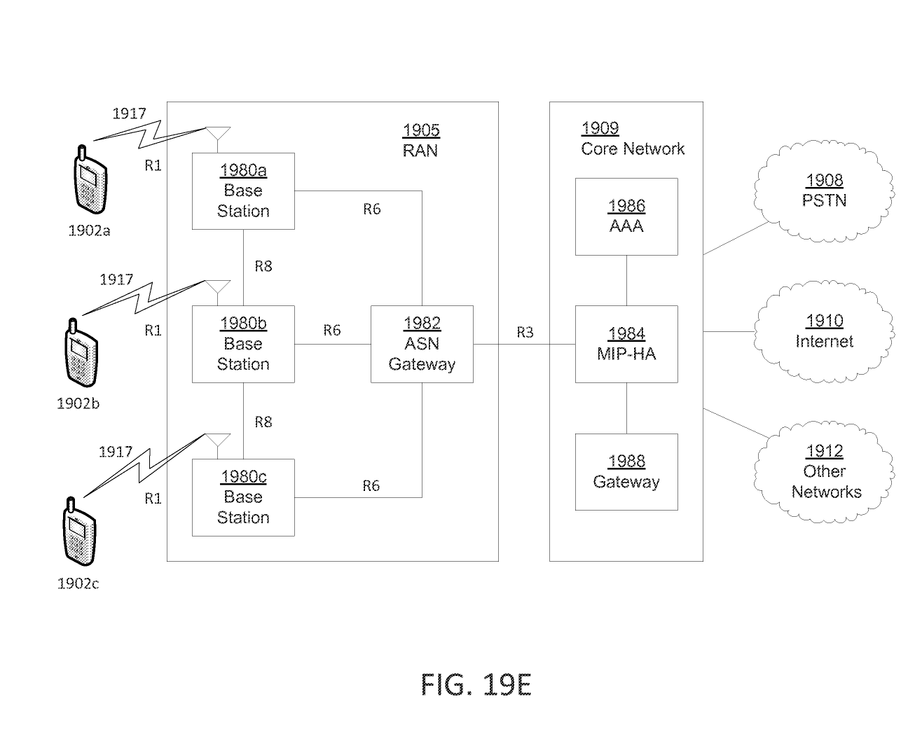

FIG. 19A is a diagram of an example communications system 1900 in which one or more disclosed embodiments may be implemented. The communications system 1900 may be a multiple access system that provides content, such as voice, data, video, messaging, broadcast, etc., to multiple wireless users. The communications system 1900 may enable multiple wireless users to access such content through the sharing of system resources, including wireless bandwidth. For example, the communications systems 1900 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 19A, the communications system 1900 may include wireless transmit/receive units (WTRUs) 1902a, 1902b, 1902c, and/or 1902d (which generally or collectively may be referred to as WTRU 102), a radio access network (RAN) 1903/1904/1905, a core network 1906/1907/1909, a public switched telephone network (PSTN) 1908, the Internet 1910, and other networks 1912, though it will be appreciated that the disclosed embodiments contemplate any number of WTRUs, base stations, networks, and/or network elements. Each of the WTRUs 1902a, 1902b, 1902c, 1902d may be any type of device configured to operate and/or communicate in a wireless environment. By way of example, the WTRUs 1902a, 1902b, 1902c, 1902d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 1900 may also include a base station 1914a and a base station 1914b. Each of the base stations 1914a, 1914b may be any type of device configured to wirelessly interface with at least one of the WTRUs 1902a, 1902b, 1902c, 1902d to facilitate access to one or more communication networks, such as the core network 1906/1907/1909, the Internet 1910, and/or the networks 1912. By way of example, the base stations 1914a, 1914b may be a base transceiver station (BTS), a Node-B, an eNode B, a Home Node B, a Home eNode B, a site controller, an access point (AP), a wireless router, and the like. While the base stations 1914a, 1914b are each depicted as a single element, it will be appreciated that the base stations 1914a, 1914b may include any number of interconnected base stations and/or network elements.

The base station 1914a may be part of the RAN 1903/1904/1905, which may also include other base stations and/or network elements (not shown), such as a base station controller (BSC), a radio network controller (RNC), relay nodes, etc. The base station 1914a and/or the base station 1914b may be configured to transmit and/or receive wireless signals within a particular geographic region, which may be referred to as a cell (not shown). The cell may further be divided into cell sectors. For example, the cell associated with the base station 1914a may be divided into three sectors. Thus, in one embodiment, the base station 1914a may include three transceivers, e.g., one for each sector of the cell. In another embodiment, the base station 1914a may employ multiple-input multiple output (MIMO) technology and, therefore, may utilize multiple transceivers for each sector of the cell.

The base stations 1914a, 1914b may communicate with one or more of the WTRUs 1902a, 1902b, 1902c, 1902d over an air interface 1915/1916/1917, which may be any suitable wireless communication link (e.g., radio frequency (RF), microwave, infrared (IR), ultraviolet (UV), visible light, etc.). The air interface 1915/1916/1917 may be established using any suitable radio access technology (RAT).

More specifically, as noted above, the communications system 1900 may be a multiple access system and may employ one or more channel access schemes, such as CDMA, TDMA, FDMA, OFDMA, SC-FDMA, and the like. For example, the base station 1914a in the RAN 1903/1904/1905 and the WTRUs 1902a, 1902b, 1902c may implement a radio technology such as Universal Mobile Telecommunications System (UMTS) Terrestrial Radio Access (UTRA), which may establish the air interface 1915/1916/1917 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 1914a and the WTRUs 1902a, 1902b, 1902c may implement a radio technology such as Evolved UMTS Terrestrial Radio Access (E-UTRA), which may establish the air interface 1915/1916/1917 using Long Term Evolution (LTE) and/or LTE-Advanced (LTE-A).

In other embodiments, the base station 1914a and the WTRUs 1902a, 1902b, 1902c may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 1914b in FIG. 19A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 1914b and the WTRUs 1902c, 1902d may implement a radio technology such as IEEE 802.11 to establish a wireless local area network (WLAN). In another embodiment, the base station 1914b and the WTRUs 1902c, 1902d may implement a radio technology such as IEEE 802.15 to establish a wireless personal area network (WPAN). In yet another embodiment, the base station 1914b and the WTRUs 1902c, 1902d may utilize a cellular-based RAT (e.g., WCDMA, CDMA2000, GSM, LTE, LTE-A, etc.) to establish a picocell or femtocell. As shown in FIG. 19A, the base station 1914b may have a direct connection to the Internet 110. Thus, the base station 1914b may not be required to access the Internet 1910 via the core network 1906/1907/1909.

The RAN 1903/1904/1905 may be in communication with the core network 1906/1907/1909, which may be any type of network configured to provide voice, data, applications, and/or voice over internet protocol (VoIP) services to one or more of the WTRUs 1902a, 1902b, 1902c, 1902d. For example, the core network 1906/1907/1909 may provide call control, billing services, mobile location-based services, pre-paid calling, Internet connectivity, video distribution, etc., and/or perform high-level security functions, such as user authentication. Although not shown in FIG. 19A, it will be appreciated that the RAN 1903/1904/1905 and/or the core network 1906/1907/1909 may be in direct or indirect communication with other RANs that employ the same RAT as the RAN 1903/1904/1905 or a different RAT. For example, in addition to being connected to the RAN 1903/1904/1905, which may be utilizing an E-UTRA radio technology, the core network 1906/1907/1909 may also be in communication with another RAN (not shown) employing a GSM radio technology.

The core network 1906/1907/1909 may also serve as a gateway for the WTRUs 1902a, 1902b, 1902c, 1902d to access the PSTN 1908, the Internet 1910, and/or other networks 1912. The PSTN 1908 may include circuit-switched telephone networks that provide plain old telephone service (POTS). The Internet 1910 may include a global system of interconnected computer networks and devices that use common communication protocols, such as the transmission control protocol (TCP), user datagram protocol (UDP) and the interact protocol (IP) in the TCP/IP interact protocol suite. The networks 1912 may include wired or wireless communications networks owned and/or operated by other service providers. For example, the networks 1912 may include another core network connected to one or more RANs, which may employ the same RAT as the RAN 1903/19904/105 or a different RAT.

Some or all of the WTRUs 1902a, 1902b, 1902c, 1902d in the communications system 1900 may include multi-mode capabilities, e.g., the WTRUs 1902a, 1902b, 1902c, 1902d may include multiple transceivers for communicating with different wireless networks over different wireless links. For example, the WTRU 1902c shown in FIG. 19A may be configured to communicate with the base station 1914a, which may employ a cellular-based radio technology, and with the base station 1914b, which may employ an IEEE 802 radio technology.

FIG. 19B is a system diagram of an example WTRU 1902. As shown in FIG. 19B, the WTRU 1902 may include a processor 1918, a transceiver 1920, a transmit/receive element 1922, a speaker/microphone 1924, a keypad 1926, a display/touchpad 1928, non-removable memory 1930, removable memory 1932, a power source 1934, a global positioning system (GPS) chipset 1936, and other peripherals 1938. It will be appreciated that the WTRU 1902 may include any sub-combination of the foregoing elements while remaining consistent with an embodiment. Also, embodiments contemplate that the base stations 1914a and 1914b, and/or the nodes that base stations 1914a and 1914b may represent, such as but not limited to transceiver station (BTS), Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 19B and described herein.

The processor 1918 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 1918 may perform signal coding, data processing, power control, input/output processing, and/or any other functionality that enables the WTRU 1902 to operate in a wireless environment. The processor 1918 may be coupled to the transceiver 1920, which may be coupled to the transmit/receive element 1922. While FIG. 19B depicts the processor 1918 and the transceiver 1920 as separate components, it will be appreciated that the processor 1918 and the transceiver 1920 may be integrated together in an electronic package or chip.

The transmit/receive element 1922 may be configured to transmit signals to, or receive signals from, a base station (e.g., the base station 1914a) over the air interface 1915/1916/1917. For example, in one embodiment, the transmit/receive element 1922 may be an antenna configured to transmit and/or receive RF signals. In another embodiment, the transmit/receive element 1922 may be an emitter/detector configured to transmit and/or receive IR, UV, or visible light signals, for example. In yet another embodiment, the transmit/receive element 1922 may be configured to transmit and receive both RF and light signals. It will be appreciated that the transmit/receive element 1922 may be configured to transmit and/or receive any combination of wireless signals.

In addition, although the transmit/receive element 1922 is depicted in FIG. 19B as a single element, the WTRU 1902 may include any number of transmit/receive elements 1922. More specifically, the WTRU 1902 may employ MIMO technology. Thus, in one embodiment, the WTRU 1902 may include two or more transmit/receive elements 1922 (e.g., multiple antennas) for transmitting and receiving wireless signals over the air interface 1915/1916/1917.

The transceiver 1920 may be configured to modulate the signals that are to be transmitted by the transmit/receive element 1922 and to demodulate the signals that are received by the transmit/receive element 1922. As noted above, the WTRU 1902 may have multi-mode capabilities. Thus, the transceiver 1920 may include multiple transceivers for enabling the WTRU 1902 to communicate via multiple RATs, such as UTRA and IEEE 802.11, for example.

The processor 1918 of the WTRU 1902 may be coupled to, and may receive user input data from, the speaker/microphone 1924, the keypad 1926, and/or the display/touchpad 1928 (e.g., a liquid crystal display (LCD) display unit or organic light-emitting diode (OLED) display unit). The processor 1918 may also output user data to the speaker/microphone 1924, the keypad 1926, and/or the display/touchpad 1928. In addition, the processor 1918 may access information from, and store data in, any type of suitable memory, such as the non-removable memory 1930 and/or the removable memory 1932. The non-removable memory 1930 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 1918 may access information from, and store data in, memory that is not physically located on the WIRE 1902, such as on a server or a home computer (not shown).

The processor 1918 may receive power from the power source 1934, and may be configured to distribute and/or control the power to the other components in the WTRU 1902. The power source 1934 may be any suitable device for powering the WTRU 1902. For example, the power source 1934 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 1918 may also be coupled to the GPS chipset 1936, which may be configured to provide location information (e.g., longitude and latitude) regarding the current location of the WTRU 1902. In addition to, or in lieu of, the information from the GPS chipset 1936, the WTRU 1902 may receive location information over the air interface 1915/1916/1917 from a base station (e.g., base stations 1914a, 1914b ) and/or determine its location based on the timing of the signals being received from two or more nearby base stations. It will be appreciated that the WTRU 1902 may acquire location information by way of any suitable location-determination method while remaining consistent with an embodiment.

The processor 1918 may further be coupled to other peripherals 1938, which may include one or more software and/or hardware modules that provide additional features, functionality and/or wired or wireless connectivity. For example, the peripherals 1938 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 19C is a system diagram of the RAN 1903 and the core network 1906 according to an embodiment. As noted above, the RAN 1903 may employ a UTRA radio technology to communicate with the WTRUs 1902a, 1902b, 1902c over the air interface 1915. The RAN 1903 may also be in communication with the core network 1906. As shown in FIG. 19C, the RAN 1903 may include Node-Bs 1940a, 1940b, 1940c, which may each include one or more transceivers for communicating with the WTRUs 1902a, 1902b, 1902c over the air interface 1915. The Node-Bs 1940a, 1940b, 1940c may each be associated with a particular cell (not shown) within the RAN 1903. The RAN 1903 may also include RNCs 1942a, 1942b. It will be appreciated that the RAN 1903 may include any number of Node-Bs and RNCs while remaining consistent with an embodiment.

As shown in FIG. 19C, the Node-Bs 1940a, 1940b may be in communication with the RNC 1942a. Additionally, the Node-B 1940c may be in communication with the RNC 1942b. The Node-Bs 1940a, 1940b, 1940c may communicate with the respective RNCs 1942a, 1942b via an Iub interface. The RNCs 1942a, 1942b may be in communication with one another via an Iur interface. Each of the RNCs 142a, 142b may be configured to control the respective Node-Bs 1940a, 1940b, 1940c to which it is connected. In addition, each of the RNCs 1942a, 1942b may be configured to carry out or support other functionality, such as outer loop power control, load control, admission control, packet scheduling, handover control, macrodiversity, security functions, data encryption, and the like.

The core network 1906 shown in FIG. 19C may include a media gateway (MGW) 1944, a mobile switching center (MSC) 1946, a serving GPRS support node (SGSN) 1948, and/or a gateway GPRS support node (GGSN) 1950. While each of the foregoing elements are depicted as part of the core network 1906, it will be appreciated that any one of these elements may be owned and/or operated by an entity other than the core network operator.

The RNC 1942a in the RAN 1903 may be connected to the MSC 1946 in the core network 1906 via an IuCS interface. The MSC 1946 may be connected to the MGW 1944. The MSC 1946 and the MGW 1944 may provide the WTRUs 1902a, 1902b, 1902c with access to circuit-switched networks, such as the PSTN 1908, to facilitate communications between the WTRUs 1902a, 1902b, 1902c and traditional land-line communications devices.

The RNC 142a in the RAN 103 may also be connected to the SGSN 1948 in the core network 1906 via an IuPS interface. The SGSN 1948 may be connected to the GGSN 1950. The SGSN 1948 and the GGSN 1950 may provide the WTRUs 1902a, 1902b, 1902c with access to packet-switched networks, such as the Internet 1910, to facilitate communications between and the WTRUs 1902a, 1902b, 1902c and IP-enabled devices.

As noted above, the core network 1906 may also be connected to the networks 1912, which may include other wired or wireless networks that are owned and/or operated by other service providers.

FIG. 19D is a system diagram of the RAN 1904 and the core network 1907 according to an embodiment. As noted above, the RAN 1904 may employ an E-UTRA radio technology to communicate with the WTRUs 1902a, 1902b, 1902c over the air interface 1916. The RAN 1904 may also be in communication with the core network 1907.

The RAN 1904 may include eNode-Bs 1960a, 1960b, 19960c, though it will be appreciated that the RAN 1904 may include any number of eNode-Bs while remaining consistent with an embodiment. The eNode-Bs 1960a, 1960b, 1960c may each include one or more transceivers for communicating with the WTRUs 1902a, 1902b, 1902c over the air interface 1916. In one embodiment, the eNode-Bs 1960a, 1960b, 1960c may implement MIMO technology. Thus, the eNode-B 1960a, for example, may use multiple antennas to transmit wireless signals to, and receive wireless signals from, the WTRU 102a.

Each of the eNode-Bs 1960a, 1960b, 1960c may be associated with a particular cell (not shown) and may be configured to handle radio resource management decisions, handover decisions, scheduling of users in the uplink and/or downlink, and the like. As shown in FIG. 19D, the eNode-Bs 1960a, 1960b, 1960c may communicate with one another over an X2 interface.

The core network 1907 shown in FIG. 19D may include a mobility management gateway (MME) 1962, a serving gateway 1964, and a packet data network (PDN) gateway 1966. While each of the foregoing elements are depicted as part of the core network 1907, it will be appreciated that any one of these elements may be owned and/or operated by an entity other than the core network operator.

The MME 1962 may be connected to each of the eNode-Bs 1960a, 1960b, 1960c in the RAN 1904 via an S1 interface and may serve as a control node. For example, the MME 1962 may be responsible for authenticating users of the WTRUs 1902a, 1902b, 1902c, bearer activation/deactivation, selecting a particular serving gateway during an initial attach of the WTRUs 1902a, 1902b, 1902c, and the like. The MME 1962 may also provide a control plane function for switching between the RAN 1904 and other RANs (not shown) that employ other radio technologies, such as GSM or WCDMA.

The serving gateway 1964 may be connected to each of the; Node-Bs 1960a, 1960b, 1960c in the RAN 1904 via the S1 interface. The serving gateway 164 may generally route and forward user data packets to/from the WTRUs 1902a, 1902b, 1902c. The serving gateway 1964 may also perform other functions, such as anchoring user planes during inter-eNode B handovers, triggering paging when downlink data is available for the WTRUs 1902a, 1902b, 1902c, managing and storing contexts of the WTRUs 1902a, 1902b, 1902c, and the like.

The serving gateway 1964 may also be connected to the PDN gateway 1966, which may provide the WTRUs 1902a, 1902b, 1902c with access to packet-switched networks, such as the Internet 1910, to facilitate communications between the WTRUs 1902a, 1902b, 1902c and IP-enabled devices.

The core network 1907 may facilitate communications with other networks. For example, the core network 1907 may provide the WTRUs 1902a, 1902b, 1902c with access to circuit-switched networks, such as the PSTN 1908, to facilitate communications between the WTRUs 1902a, 1902b, 1902c and traditional land-line communications devices. For example, the core network 1907 may include, or may communicate with, an IP gateway (e.g., an IP multimedia subsystem (IMS) server) that serves as an interface between the core network 1907 and the PSTN 108. In addition, the core network 1907 may provide the WTRUs 1902a, 1902b, 1902c with access to the networks 1912, which may include other wired or wireless networks that are owned and/or operated by other service providers.

FIG. 19E is a system diagram of the RAN 1905 and the core network 1909 according to an embodiment. The RAN 1905 may be an access service network (ASN) that employs IEEE 802.16 radio technology to communicate with the WTRUs 1902a, 1902b, 1902c over the air interface 1917. As will be further discussed below, the communication links between the different functional entities of the WTRUs 1902a, 1902b, 1902c, the RAN 1905, and the core network 1909 may be defined as reference points.

As shown in FIG. 19E, the RAN 1905 may include base stations 1980a, 1980b, 1980c, and an ASN gateway 1982, though it will be appreciated that the RAN 1905 may include any number of base stations and ASN gateways while remaining consistent with an embodiment. The base stations 1980a, 1980b, 1980c may each be associated with a particular cell (not shown) in the RAN 1905 and may each include one or more transceivers for communicating with the WTRUs 1902a, 1902b, 1902c over the air interface 1917. In one embodiment, the base stations 1980a, 1980b, 1980c may implement MIMO technology. Thus, the base station 1980a, for example, may use multiple antennas to transmit wireless signals to, and receive wireless signals from, the WTRU 1902a. The base stations 1980a, 1980b, 1980c may also provide mobility management functions, such as handoff triggering, tunnel establishment, radio resource management, traffic classification, quality of service (QoS) policy enforcement, and the like. The ASN gateway 1982 may serve as a traffic aggregation point and may be responsible for paging, caching of subscriber profiles, routing to the core network 1909, and the like.

The air interface 1917 between the WTRUs 1902a, 1902b, 1902c and the RAN 1905 may be defined as an R1 reference point that implements the IEEE 802.16 specification. In addition, each of the WTRUs 1902a, 1902b, 1902c may establish a logical interface (not shown) with the core network 1909. The logical interface between the WTRUs 1902a, 1902b, 1902c and the core network 1909 may be defined as an R2 reference point, which may be used for authentication, authorization, IP host configuration management, and/or mobility management.

The communication link between each of the base stations 1980a, 1980b, 1980c may be defined as an R8 reference point that includes protocols for facilitating WTRU handovers and the transfer of data between base stations. The communication link between the base stations 180a, 1980b, 1980c and the ASN gateway 1982 may be defined as an R6 reference point. The R6 reference point may include protocols for facilitating mobility management based on mobility events associated with each of the WTRUs 1902a, 1902b, 1902c.

As shown in FIG. 19E, the RAN 1905 may be connected to the core network 1909. The communication link between the RAN 1905 and the core network 1909 may defined as an R3 reference point that includes protocols for facilitating data transfer and mobility management capabilities, for example. The core network 1909 may include a mobile IP home agent (MIP-HA) 1984, an authentication, authorization, accounting (AAA) server 1986, and a gateway 1988. While each of the foregoing elements are depicted as part of the core network 1909, it will be appreciated that any one of these elements may be owned and/or operated by an entity other than the core network operator.

The MIP-HA may be responsible for IP address management, and may enable the WTRUs 1902a, 1902b, 1902c to roam between different ASNs and/or different core networks. The MIP-HA 1984 may provide the WTRUs 1902a, 1902b, 1902c with access to packet-switched networks, such as the Internet 1910, to facilitate communications between the WTRUs 1902a, 1902b, 1902c and IP-enabled devices. The AAA server 1986 may be responsible for user authentication and for supporting user services. The gateway 1988 may facilitate interworking with other networks. For example, the gateway 1988 may provide the WTRUs 1902a, 1902b, 1902c with access to circuit-switched networks, such as the PSTN 1908, to facilitate communications between the WTRUs 1902a, 1902b, 1902c and traditional land-line communications devices. In addition, the gateway 1988 may provide the WTRUs 1902a, 1902b, 1902c with access to the networks 1912, which may include other wired or wireless networks that are owned and/or operated by other service providers.

Although not shown in FIG. 19E, it will be appreciated that the RAN 1905 may be connected to other ASNs and the core network 1909 may be connected to other core networks. The communication link between the RAN 1905 the other ASNs may be defined as an R4 reference point, which may include protocols for coordinating the mobility of the WTRUs 1902a, 1902b, 1902c between the RAN 1905 and the other ASNs. The communication link between the core network 1909 and the other core networks may be defined as an R5 reference, which may include protocols for facilitating interworking between home core networks and visited core networks.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A video coding device comprising:
a processor configured to:
evaluate a plurality of error concealment modes for a first picture of a plurality of pictures in a video input;
select an error concealment mode from the plurality of error concealment modes for the first picture; and
signal the selected error concealment mode for the first picture in a video bitstream.

2. The video coding device of claim 1, wherein the processor is configured to:
evaluate the plurality of error concealment modes for a second picture of the plurality of pictures in the video input;
select an error concealment mode from the plurality of error concealment modes for the second picture; and
signal the selected error concealment mode for the second picture and the selected error concealment mode for the first picture in the video bitstream, wherein the selected error concealment mode for the first picture is different from the selected error concealment mode for the second picture.

3. The video coding device of claim 1, wherein the processor is configured to:
evaluate the plurality of error concealment modes for a second picture;
select an error concealment mode from the plurality of error concealment modes for the second picture; and
signal the selected error concealment mode for the second picture and the selected error concealment mode for the first picture in the video bitstream, wherein the selected error concealment mode for the first picture is the same as the selected error concealment mode for the second picture.

4. The video coding device of claim 1, wherein the processor is configured to select the error concealment mode based on a disparity between the first picture and an error concealed version of the first picture, and wherein the processor selects the error concealment mode having a smallest calculated disparity.

5. The video coding device of claim 4, wherein the disparity is measured according to one or more of a sum of absolute differences (SAD) or a structural similarity (SSIM) between the first picture and the error concealed version of the first picture determined using the selected EC mode.

6. The video coding device of claim 4, wherein the disparity is measured using one or more color components of the first picture.

7. The video coding device of claim 1, wherein the plurality of error concealment modes comprises at least two of Picture Copy (PC), Temporal Direct (TD), Motion Copy (MC), Base Layer Skip (BL Skip; Motion & Residual up sampling), Reconstructed BL upsampling (RU), E-ILR Mode 1, or E-ILR Mode 2.

8. The video coding device of claim 1, wherein signal the selected error concealment mode for the first picture in the video bitstream comprises signal the error concealment mode in a supplemental enhancement information (SEI) message of the video bitstream, an MPEG media transport (MMT) transport packet, or an MMT error concealment mode (ECM) message.

9. The video coding device of claim 1, wherein the processor is configured to:
evaluate two or more error concealment modes for each picture in the plurality of pictures;
divide the plurality of pictures into a first subset of pictures and a second subset of pictures;
select an error concealment mode from the two or more evaluated error concealment modes for each picture in the plurality of pictures, wherein the selected error concealment mode for the first subset of pictures is the same and the selected error concealment mode for the second subset of pictures is the same; and
signal the selected error concealment mode for the first subset of pictures and the selected error concealment mode for the second subset of pictures in the video bitstream.

10. The video coding device of claim 1, wherein the processor is configured to:
determine that a higher layer of the video input exists, wherein the higher layer is higher than a layer comprising the first picture;
select a picture from the plurality of pictures in the higher layer of the video input;
evaluate two or more error concealment modes for the selected picture of the higher layer;
select an error concealment mode from the two or more evaluated error concealment modes for the selected picture from the higher layer; and
signal the selected error concealment mode for the selected picture of the higher layer in the video bitstream with the error concealment mode for the first picture.

11. A video coding device comprising:
a processor configured to:
receive a video bitstream comprising a plurality of pictures associated with a plurality of layers;
receive an error concealment mode for a first picture layer in the video bitstream;
determine that a first picture associated with the first layer is lost; and
perform error concealment for the first picture using the received error concealment mode for the first layer.

12. The video coding device of claim 11, wherein the processor is configured to:
receive an error concealment mode for a second layer in the video bitstream;
determine that a second picture associated with the second layer is lost; and
perform error concealment for the second picture using the received error concealment mode for the second layer.

13. The video coding device of claim 12, wherein the error concealment mode for the second layer is the same as the error concealment mode for the first layer.

14. The video coding device of claim 12, wherein the error concealment mode for the second layer is the same as the error concealment mode for the first layer.

15. A video coding device comprising:
a processor configured to:
evaluate two or more error concealment modes for a layer;
select an error concealment mode from the two or more error concealment modes; and
signal the selected error concealment mode in a video bitstream for the layer.

16. The video coding device of claim 15, wherein the two or more error concealment modes comprises at least two of Picture Copy (PC), Temporal Direct (TD), Motion Copy (MC), Base Layer Skip (BL Skip; Motion & Residual up sampling), Reconstructed BL upsampling (RU), E-ILR Mode 1, or E-ILR Mode 2.

17-32. (canceled)

33. The video coding device of claim 15, wherein the processor is configured to select the error concealment mode based on a disparity between a picture in the layer and an error concealed version of the picture, and wherein the processor is configured to select the error concealment mode having a smallest calculated disparity.

34. The video coding device of claim 33, wherein the disparity is measured according to one or more of a sum of absolute differences (SAD) or a structural similarity (SSIM) between the first picture and the error concealed version of the first picture determined using the selected EC mode.

35. The video coding device of claim 14, wherein the processor is configured to:
evaluate the plurality of error concealment modes for a second layer in the video input;
select an error concealment mode from the plurality of error concealment modes for the second layer; and
signal the selected error concealment mode for the second layer in the video bitstream.
